(19) United States
(12) Patent Application Publication
(10) Pub. No.: US 2024/0396024 A1
(43) Pub. Date: Nov. 28, 2024

(54) POSITIVE ELECTRODE MATERIAL, AND POSITIVE ELECTRODE PLATE AND BATTERY INCLUDING POSITIVE ELECTRODE MATERIAL

(71) Applicant: ZHUHAI COSMX BATTERY CO., LTD., Zhuhai (CN)

(72) Inventors: Jiajiang ZENG, Zhuhai (CN); Suli LI, Zhuhai (CN)

(73) Assignee: ZHUHAI COSMX BATTERY CO., LTD., Zhuhai (CN)

(21) Appl. No.: 18/775,378

(22) Filed: Jul. 17, 2024

Related U.S. Application Data
(63) Continuation of application No. PCT/CN2023/072901, filed on Jan. 18, 2023.

(30) Foreign Application Priority Data
Jan. 21, 2022 (CN) 202210072994.2
Jan. 24, 2022 (CN) 202210082272.5

(51) Int. Cl. H01M 4/36; H01M 4/02; H01M 4/58; H01M 4/62; H01M 10/0525

(52) U.S. Cl. CPC H01M 4/366; H01M 4/5825; H01M 4/625; H01M 10/0525; H01M 2004/021; H01M 2004/028

(57) ABSTRACT

Disclosed are a positive electrode material, and a positive electrode plate and a battery including the positive electrode material. The positive electrode material includes a positive electrode active material and a coating material on a surface of the positive electrode active material; a median particle size Dv50 of the positive electrode material ranges from 2 μm to 7 μm; a chemical formula of the positive electrode active material is LiₐFeₓMn_{1-x-y-z}M_{y}N_{z}PO₄, where M and N are co-doping elements, 0.9≤a≤1.1, 0≤x≤1, 0≤y≤0.02, and 0≤z≤0.02; and a median particle size Dv50 of the positive electrode material ranges from 2 μm to 7 μm. Therefore, a battery having a relatively high dynamic performance, low-temperature discharge performance, and safety performance may be obtained.

### CROSS-REFERENCE TO RELATED APPLICATIONS

The present disclosure is a continuation of International Application No. PCT/CN2023/072901, filed on Jan. 18, 2023, which claims priority to Chinese Patent Application No. 202210072994.2, filed on Jan. 21, 2022, and to Chinese Patent Application No. 202210082272.5, filed on Jan. 24, 2022. The disclosures of the aforementioned applications are hereby incorporated by reference in their entireties.

### TECHNICAL FIELD

The present disclosure pertains to the field of battery technologies, and relates to a positive electrode material, and a positive electrode plate and a battery including the positive electrode material.

### BACKGROUND

Batteries have been applied and popularized in the fields of portable electric appliances, power storage systems and the like, implementing wireless revolution of mobile phones, notebook computers, and digital cameras. Therefore, batteries are key components of portable electric appliances and telecommunication devices needed in today's society. As an important component of a battery, a positive electrode material is closely related to the performance of the battery.

With a relatively low electronic conductivity and lithium-ion diffusion coefficient, a conventional olivine-type positive electrode material has obvious shortcomings in C-rate performance and low-temperature performance, impacting a performance of a battery having the positive electrode material. In addition, a preparation process of the positive electrode material is complex, limiting its large-scale production.

### SUMMARY

To overcome the foregoing deficiencies and defects, the present disclosure provides a positive electrode material and a preparation method thereof, a positive electrode plate including the positive electrode material, and a battery including the positive electrode material. A median particle size of the positive electrode material is within a specific range, so that a battery having a relatively high dynamic performance, low-temperature discharge performance, and safety performance may be obtained.

Technical solutions proposed in the present disclosure are as follows.

A positive electrode material is provided. The positive electrode material includes a positive electrode active material and a coating material on a surface of the positive electrode active material; a median particle size Dv50 of the positive electrode material ranges from 2 μm to 7 μm; and a chemical formula of the positive electrode active material is LiₐFeₓMn_{1-x-y-z}M_{y}N_{z}PO₄, where M and N are co-doping elements, 0.9≤a≤1.1, 0≤x≤1, 0≤y≤0.02, and 0≤z≤0.02.

Beneficial effects of the present disclosure are as follows.

Firstly, in the positive electrode material of the present disclosure, two elements are doped, and an effective synergistic effect is formed between the two elements, so that the electronic conductivity and lithium-ion diffusion rate of the positive electrode material are improved obviously, and a battery having the positive electrode material has a good electrochemical performance. Doping of metal ions improves the electronic conductivity and ion diffusion rate of the positive electrode material, and the synergistic effect of two-element doping can improve the capacity per gram for discharging and cycling performance of the positive electrode material. Compared with single-element doping or none doping, two-element doping can improve the electrochemical performance of the positive electrode material from various aspects.

Secondly, when the positive electrode material of the present disclosure is prepared into a positive electrode plate, and the positive electrode plate is used at a lithium-ion battery level, an excellent cycling performance and a high output power performance are achieved. When the positive electrode material is used at a battery, the safety performance is relatively high.

Lastly, when the positive electrode material of the present disclosure is prepared into a positive electrode plate, and the positive electrode plate is used in a battery, the initial charge/discharge efficiency, coulombic efficiency, low-temperature performance, C-rate performance, and safety performance of a battery of the battery are improved obviously, resolving problems such as a low lithium-ion diffusion velocity and a polarization phenomenon in the prior art, and obviously improving the safety performance and C-rate performance of the material.

### BRIEF DESCRIPTION OF THE DRAWINGS

FIG. 1 is a schematic structural diagram of a positive electrode material according to the present disclosure.

FIG. 2 is an XRD spectrum of a positive electrode material in Example 1.

FIG. 3 is an SEM image of a section of a positive electrode material in Example 1.

FIG. 4 is an SEM image of a section of a positive electrode material in Comparative Example 1.

FIG. 5 is an XRD spectrum of a lithium manganese iron phosphate positive electrode material in Example 5.

FIG. 6 is an SEM image of a lithium manganese iron phosphate positive electrode material in Example 5.

FIG. 7 is an SEM image of a section of a lithium manganese iron phosphate positive electrode material in Example 5.

FIG. 8 is a graph of nitrogen gas adsorption-desorption curves of a lithium manganese iron phosphate positive electrode material in Example 5.

FIG. 9 is an SEM image of a section of a positive electrode material in Example 9.

FIG. 10 is an XRD spectrum of a doped lithium manganese iron phosphate positive electrode material in Example 9.

FIG. 11 is an SEM image of a section of a lithium manganese iron phosphate positive electrode material in Comparative Example 2.

FIG. 12 is a graph of charge-discharge curves (of a button battery) in Example 1.

FIG. 13 is a graph of charge-discharge curves (of a button battery) in Comparative Example 1.

FIG. 14 is a graph of charge-discharge curves (of a button battery) in Example 5.

FIG. 15 is a graph of charge-discharge curves (of a button battery) in Comparative Example 2.

FIG. 16 is a graph of charge-discharge curves in Example 9.

FIG. 17 is a graph of C-rate performances (of a soft-package battery) in Example 5.

FIG. 18 is a graph of 45° C. cycling capacity retention rates in Example 9.

FIG. 19 is a graph of 25° C. cycling capacity retention rates of a soft-package battery in Example 1.

FIG. 20 is a graph of 45° C. cycling capacity retention rates of a soft-package battery in Example 1.

FIG. 21 is a graph of impedances in Example 9.

FIG. 22 is a TEM spectrum of a positive electrode material according to an example of the present disclosure.

### DETAILED DESCRIPTION OF THE EMBODIMENTS

The present disclosure provides a positive electrode material. The positive electrode material includes a positive electrode active material and a coating material on a surface of the positive electrode active material; and a median particle size Dv50 of the positive electrode material ranges from 2 μm to 7 μm, for example, the median particle size Dv50 of the positive electrode material is 2 μm, 3 μm, 4 μm, 5 μm, 6 μm, 7 μm, or a point value in a range formed by any two of the foregoing values.

A chemical formula of the positive electrode active material is LiₐFeₓMn_{1-x-y-z}M_{y}N_{z}PO₄, where M and N are co-doping elements, 0.9≤a≤1.1 (for example, a=0.9, 0.91, 0.92, 0.93, 0.94, 0.95, 0.96, 0.97, 0.98, 0.99, 1, 1.01, 1.02, 1.03, 1.04, 1.05, 1.06, 1.07, 1.08, 1.09, 1.1, or a point value in a range formed by any two of the foregoing values), 0≤x≤1 (for example, x=0, 0.1, 0.2, 0.3, 0.4, 0.5, 0.6, 0.7, 0.8, 0.9, 1, or a point value in a range formed by any two of the foregoing values), 0≤y≤0.02 (for example, y=0, 0.001, 0.002, 0.003, 0.004, 0.005, 0.006, 0.007, 0.008, 0.009, 0.01, 0.011, 0.012, 0.013, 0.014, 0.015, 0.016, 0.017, 0.018, 0.019, 0.02, or a point value in a range formed by any two of the foregoing values), and 0≤z≤0.02 (for example, z=0, 0.001, 0.002, 0.003, 0.004, 0.005, 0.006, 0.007, 0.008, 0.009, 0.01, 0.011, 0.012, 0.013, 0.014, 0.015, 0.016, 0.017, 0.018, 0.019, 0.02, or a point value in a range formed by any two of the foregoing values).

According to an implementation of the present disclosure, 0.96≤a≤1.1.

According to an implementation of the present disclosure, M is selected from at least one of niobium (Nb), magnesium (Mg), cobalt (Co), zinc (Zn), nickel (Ni), or copper (Cu), for example, is niobium (Nb).

According to an implementation of the present disclosure, N is selected from at least one of aluminum (Al), titanium (Ti), vanadium (V), or cerium (Ce), for example, is vanadium (V).

According to an implementation of the present disclosure, the positive electrode active material has an olivine-type structure.

According to an implementation of the present disclosure, the positive electrode active material is a secondary spherical particle; the secondary spherical particle includes a kernel region and a shell region; the shell region is on an outer layer of the kernel region; the shell region has an aggregated dense structure; and the kernel region has an aggregated loose structure.

It is found through research that a hollow structure may provide a plurality of paths for diffusion of lithium ions, resolving problems such as a low lithium diffusion velocity and polarization of a positive electrode material in the prior art. In addition, a positive electrode plate including the positive electrode material and a battery including the positive electrode material have good C-rate performances and dynamic performances, and especially have good low-temperature discharge performances.

According to an implementation of the present disclosure, the coating material includes a carbon material. Preferably, the carbon material includes amorphous carbon.

According to an implementation of the present disclosure, a thickness of the coating material ranges from 2 nm to 10 nm, for example, is 2 nm, 3 nm, 4 nm, 5 nm, 6 nm, 7 nm, 8 nm, 9 nm, 10 nm, or a point value in a range formed by any two of the foregoing values.

As shown in FIG. 22 which is a TEM spectrum of a positive electrode material according to an example of the present disclosure, a thickness of “Carbon” marked in the lower-right corner of the figure is the thickness of the coating material.

According to an implementation of the present disclosure, a specific surface area of the positive electrode material ranges from 8 m²/g to 25 m²/g, for example, is 8 m²/g, 9 m²/g, 10 m²/g, 11 m²/g, 12 m²/g, 13 m²/g, 14 m²/g, 15 m²/g, 16 m²/g, 17 m²/g, 18 m²/g, 19 m²/g, 20 m²/g, 21 m²/g, 22 m²/g, 23 m²/g, 24 m²/g, 25 m²/g, or a point value in a range formed by any two of the foregoing values.

According to an implementation of the present disclosure, the chemical formula of the positive electrode active material is LiₐMn_{1-y-z}M_{y}N_{z}PO₄.

According to an implementation of the present disclosure, the chemical formula of the positive electrode active material is LiMnPO₄.

According to an implementation of the present disclosure, the positive electrode active material is lithium manganese phosphate.

According to an implementation of the present disclosure, a median particle size Dv50 of the positive electrode material ranges from 2 μm to 5 μm.

According to an implementation of the present disclosure, the shell region has a pore. For example, a porosity of the shell region ranges from 10% to 35%, for example, is 10%, 12%, 15%, 18%, 20%, 22%, 25%, 28%, 30%, 32%, 35%, or a point value in a range formed by any two of the foregoing values.

According to an implementation of the present disclosure, the kernel region also has a pore; and a porosity of the kernel region is greater than the porosity of the shell region. For example, the porosity of the kernel region ranges from 60% to 90%, for example, is 60%, 62%, 65%, 68%, 70%, 72%, 75%, 78%, 80%, 82%, 85%, 88%, 90%, or a point value in a range formed by any two of the foregoing values.

A method for testing the porosity is not specifically limited in the present disclosure. The porosity may be tested according to a method known in the art.

According to an implementation of the present disclosure, a thickness of the coating material ranges from 2 nm to 8 nm.

According to an implementation of the present disclosure, a specific surface area of the positive electrode material ranges from 15 m²/g to 25 m²/g.

According to an implementation of the present disclosure, an electronic conductivity of LiₐMn_{1-y-z}M_{y}N_{z}PO₄ ranges from 1×10⁻⁵ S/cm to 9×10⁻⁵ S/cm, for example, is 1×10⁻⁵ S/cm, 2×10⁻⁵ S/cm, 3×10⁻⁵ S/cm, 4×10⁻⁵ S/cm, 5×10⁻⁵ S/cm, 6×10⁻⁵ S/cm, 7×10⁻⁵ S/cm, 8×10⁻⁵ S/cm, 9×10⁻⁵ S/cm, or a point value in a range formed by any two of the foregoing values.

According to an implementation of the present disclosure, a lithium-ion diffusion coefficient of LiₐMn_{1-y-z}M_{y}N_{z}PO₄ ranges from 1×10⁻¹⁴ cm²/s to 8×10⁻¹⁴ cm²/s, for example, is 1×10⁻¹⁴ cm²/s, 2×10⁻¹⁴ cm²/s, 3×10⁻¹⁴ cm²/s, 4×10⁻¹⁴ cm²/s, 5×10⁻¹⁴ cm²/s, 6×10⁻¹⁴ cm²/s, 7×10⁻¹⁴ cm²/s, 8×10⁻¹⁴ cm²/s, or a point value in a range formed by any two of the foregoing values.

According to an implementation of the present disclosure, a ratio of a mass of the positive electrode active material to a total mass of the positive electrode material ranges from 97.5 wt % to 99 wt %, for example, is 97.5 wt %, 98 wt %, 98.5 wt %, 99 wt %, or a point value in a range formed by any two of the foregoing values.

According to an implementation of the present disclosure, a ratio of a mass of the coating material to the total mass of the positive electrode material ranges from 1 wt % to 2.5 wt %, for example, is 1 wt %, 1.5 wt %, 2 wt %, 2.5 wt %, or a point value in a range formed by any two of the foregoing values.

According to an implementation of the present disclosure, a median particle size Dv50 of the kernel region of the positive electrode active material ranges from 1.2 μm to 2.6 μm, for example, is 1.2 μm, 1.3 μm, 1.4 μm, 1.5 μm, 1.6 μm, 1.7 μm, 1.8 μm, 1.9 μm, 2 μm, 2.1 μm, 2.2 μm, 2.3 μm, 2.4 μm, 2.5 μm, 2.6 μm, or a point value in a range formed by any two of the foregoing values.

According to an implementation of the present disclosure, components of the kernel region and the shell region of the positive electrode active material are the same, and both are lithium manganese phosphate LiMnPO₄.

According to an implementation of the present disclosure, the secondary spherical particle is a spherical secondary particle structure formed by stacking primary particles of lithium manganese phosphate LiMnPO₄.

According to an implementation of the present disclosure, the kernel region is formed by aggregation of primary particles of lithium manganese phosphate LiMnPO₄ having small particle sizes (ranging from 200 nm to 300 nm), and the kernel region is an aggregated loose structure whose porosity ranges from 60% to 90%.

According to an implementation of the present disclosure, the shell region is formed by aggregation of primary particles of lithium manganese phosphate LiMnPO₄ having large particle sizes (ranging from 300 nm to 500 nm); and the shell region has an aggregated dense structure whose porosity ranges from 10% to 35%.

According to an implementation of the present disclosure, the chemical formula of the positive electrode active material is LiₐFeₓM_{y}N_{z}PO₄.

According to an implementation of the present disclosure, the chemical formula of the positive electrode active material is LiFePO₄.

According to an implementation of the present disclosure, the positive electrode active material is lithium iron phosphate.

According to an implementation of the present disclosure, the shell region has a pore. For example, a porosity of the shell region ranges from 10% to 35%, for example, is 10%, 12%, 15%, 18%, 20%, 22%, 25%, 28%, 30%, 32%, 35%, or a point value in a range formed by any two of the foregoing values.

According to an implementation of the present disclosure, the kernel region also has a pore; and a porosity of the kernel region is greater than the porosity of the shell region. For example, the porosity of the kernel region ranges from 60% to 90%, for example, is 60%, 62%, 65%, 68%, 70%, 72%, 75%, 78%, 80%, 82%, 85%, 88%, 90%, or a point value in a range formed by any two of the foregoing values.

A method for testing the porosity is not specifically limited in the present disclosure. The porosity may be tested according to a method known in the art.

According to an implementation of the present disclosure, a thickness of the coating material ranges from 2 nm to 8 nm.

According to an implementation of the present disclosure, a specific surface area of the positive electrode material ranges from 8 m²/g to 15 m²/g, for example, is 8 m²/g, 9 m²/g, 10 m²/g, 11 m²/g, 12 m²/g, 13 m²/g, 14 m²/g, 15 m²/g, or a point value in a range formed by any two of the foregoing values.

According to an implementation of the present disclosure, an electronic conductivity of LiₐFeₓM_{y}N_{z}PO₄ ranges from 2×10⁻² S/cm to 9×10⁻² S/cm, for example, is 2×10⁻² S/cm, 3×10⁻² S/cm, 4×10⁻² S/cm, 5×10⁻² S/cm, 6×10⁻² S/cm, 7×10⁻² S/cm, 8×10⁻² S/cm, 9×10⁻² S/cm, or a point value in a range formed by any two of the foregoing values.

According to an implementation of the present disclosure, a lithium-ion diffusion coefficient of LiₐFeₓM_{y}N_{z}PO₄ ranges from 1×10⁻¹ cm²/s to 9×10⁻¹¹ cm²/s, for example, is 1×10⁻¹¹ cm²/s, 2×10⁻¹¹ cm²/s, 3×10⁻¹¹ cm²/s, 4×10⁻¹¹ cm²/s, 5×10⁻¹¹ cm²/s, 6×10⁻¹¹ cm²/s, 7×10⁻¹¹ cm²/s, 8×10⁻¹¹ cm²/s, 9×10⁻¹¹ cm²/s, or a point value in a range formed by any two of the foregoing values.

According to an implementation of the present disclosure, a ratio of a mass of the positive electrode active material to a total mass of the positive electrode material ranges from 97.5 wt % to 99 wt %, for example, is 97.5 wt %, 98 wt %, 98.5 wt %, 99 wt %, or a point value in a range formed by any two of the foregoing values.

According to an implementation of the present disclosure, a ratio of a mass of the coating material to the total mass of the positive electrode material ranges from 1 wt % to 2.5 wt %, for example, is 1 wt %, 1.5 wt %, 2 wt %, 2.5 wt %, or a point value in a range formed by any two of the foregoing values.

According to an implementation of the present disclosure, a median particle size Dv50 of the kernel region of the positive electrode active material ranges from 1.2 μm to 2.6 μm, for example, is 1.2 μm, 1.3 μm, 1.4 μm, 1.5 μm, 1.6 μm, 1.7 μm, 1.8 μm, 1.9 μm, 2 μm, 2.1 μm, 2.2 μm, 2.3 μm, 2.4 μm, 2.5 μm, 2.6 μm, or a point value in a range formed by any two of the foregoing values.

According to an implementation of the present disclosure, components of the kernel region and the shell region of the positive electrode active material are the same, and both are lithium iron phosphate LiFePO₄.

According to an implementation of the present disclosure, the secondary spherical particle is a spherical secondary particle structure formed by stacking primary particles of lithium iron phosphate LiFePO₄.

According to an implementation of the present disclosure, the kernel region is formed by aggregation of primary particles of lithium iron phosphate LiFePO₄ having small particle sizes (ranging from 200 nm to 300 nm), and the kernel region is an aggregated loose structure whose porosity ranges from 60% to 90%.

According to an implementation of the present disclosure, the shell region is formed by aggregation of primary particles of lithium iron phosphate LiFePO₄ having large particle sizes (ranging from 300 nm to 500 nm), and the shell region has an aggregated dense structure whose porosity ranges from 10% to 35%.

According to an implementation of the present disclosure, in the chemical formula LiₐFeₓMn_{1-x-y-z}M_{y}N_{z}PO₄ of the positive electrode active material, 0<x≤0.6.

According to an implementation of the present disclosure, the chemical formula of the positive electrode active material is LiFeₓMn_{1-x-y-z}M_{y}N_{z}PO₄.

According to an implementation of the present disclosure, 0≤y+z≤0.04. Specifically, 0.0015≤y+z≤0.04, for example, y+z is 0.0015, 0.002, 0.003, 0.004, 0.005, 0.006, 0.007, 0.008, 0.009, 0.01, 0.02, 0.03, 0.04, or a point value in a range formed by any two of the foregoing values.

According to an implementation of the present disclosure, a molar ratio of M to N ranges from 1:1 to 3:1, for example, is 1:1, 2:1, 3:1, or a point value in a range formed by any two of the foregoing values.

According to an implementation of the present disclosure, the shell region has a pore. For example, a porosity of the shell region is greater than 0 and less than or equal to 30%, for example, is 0.1%, 0.5%, 1%, 5%, 10%, 12%, 15%, 18%, 20%, 22%, 25%, 28%, 30%, or a point value in a range formed by any two of the foregoing values.

According to an implementation of the present disclosure, the kernel region also has a pore; and a porosity of the kernel region is greater than the porosity of the shell region. For example, the porosity of the kernel region ranges from 65% to 90%, for example, is 65%, 68%, 70%, 72%, 75%, 78%, 80%, 82%, 85%, 88%, 90%, or a point value in a range formed by any two of the foregoing values.

A method for testing the porosity is not specifically limited in the present disclosure. The porosity may be tested according to a method known in the art.

According to an implementation of the present disclosure, a median particle size Dv50 of the kernel region of the positive electrode active material (namely, the secondary spherical particle) ranges from 1 μm to 2.8 μm, for example, 1 μm, 1.1 μm, 1.2 μm, 1.3 μm, 1.4 μm, 1.5 μm, 1.6 μm, 1.7 μm, 1.8 μm, 1.9 μm, 2 μm, 2.1 μm, 2.2 μm, 2.3 μm, 2.4 μm, 2.5 μm, 2.6 μm, 2.7 μm, 2.8 μm, or a point value in a range formed by any two of the foregoing values.

According to an implementation of the present disclosure, in the positive electrode material, a mass ratio of the coating material to the positive electrode active material ranges from 1:100 to 2.5:100, for example, is 1:100, 1.5:100, 2:100, 2.5:100, or a point value in a range formed by any two of the foregoing values.

According to an implementation of the present disclosure, a specific surface area of the positive electrode material ranges from 10 m²/g to 18 m²/g, for example, is 10 m²/g, 11 m²/g, 12 m²/g, 13 m²/g, 14 m²/g, 15 m²/g, 16 m²/g, 17 m²/g, 18 m²/g, or a point value in a range formed by any two of the foregoing values.

According to an implementation of the present disclosure, a capacity per gram for discharging of the positive electrode material is greater than 150 mAh/g, and is preferably greater than 150 mAh/g and less than 200 mAh/g.

The present disclosure further provides a positive electrode plate, where the positive electrode plate includes the foregoing positive electrode material.

According to an implementation of the present disclosure, the positive electrode plate may be prepared according to a method known in the art, for example, may further include a conductive agent, a binder, or another material known in the art. This is not specifically limited in the present disclosure.

According to an implementation of the present disclosure, the positive electrode plate includes a positive electrode current collector and a positive electrode active layer on a surface of the positive electrode current collector, and the positive electrode active layer includes the foregoing positive electrode material.

According to an implementation of the present disclosure, the positive electrode active layer includes the following components by mass percentage: 70 wt % to 99 wt % (for example, is 70 wt %, 80 wt %, 90 wt %, 95 wt %, 99 wt %, or a point value in a range formed by any two of the foregoing values) of the positive electrode material, 0.5 wt % to 15 wt % (for example, is 15 wt %, 10 wt %, 5 wt %, 2.5 wt %, 0.5 wt %, or a point value in a range formed by any two of the foregoing values) of the conductive agent, and 0.5 wt % to 15 wt % (for example, is 15 wt %, 10 wt %, 5 wt %, 2.5 wt %, 0.5 wt %, or a point value in a range formed by any two of the foregoing values) of the binder.

Preferably, the positive electrode active layer includes the following components by mass percentage:

96 wt % to 98 wt % of the positive electrode material, 1 wt % to 2 wt % of a conductive agent acetylene black, 1 wt % to 1.5 wt % of a conductive agent carbon nanotube, and 0.5 wt % to 1.0 wt % of a binder polyvinylidene fluoride (PVDF).

According to an implementation of the present disclosure, the positive electrode active layer includes the following components by mass percentage:

96 wt % to 97.5 wt % of the positive electrode material, 1 wt % to 2 wt % of a conductive agent acetylene black, 1 wt % to 1.5 wt % of a conductive agent carbon nanotube, and 0.5 wt % to 1.0 wt % of a binder PVDF.

The present disclosure further provides application of the foregoing positive electrode material or the foregoing positive electrode plate to a battery.

The present disclosure further provides a battery. The battery includes the foregoing positive electrode material or the foregoing positive electrode plate.

According to an implementation of the present disclosure, the battery is a lithium-ion battery.

According to an implementation of the present disclosure, the battery may be prepared according to a method known in the art, for example, may further include a negative electrode plate, a separator, an electrolyte solution, or the like. The negative electrode plate, the separator, and the electrolyte solution may be selected according to methods known in the art. This is not specifically limited in the present disclosure.

According to an implementation of the present disclosure, a bulk energy density of the battery ranges from 225 KWh/m³ to 255 KWh/m³ (for example, is 225 KWh/m³, 230 KWh/m³, 235 KWh/m³, 240 KWh/m³, 245 KWh/m³, 250 KWh/m³, 255 KWh/m³, or a point value in a range formed by any two of the foregoing values), and a mass energy density thereof ranges from 175 Wh/kg to 215 Wh/kg (for example, is 175 Wh/kg, 180 Wh/kg, 185 Wh/kg, 190 Wh/kg, 195 Wh/kg, 200 Wh/kg, 205 Wh/kg, 210 Wh/kg, 215 Wh/kg, or a point value in a range formed by any two of the foregoing values).

According to an implementation of the present disclosure, a C-rate performance of the battery is greater than 90%, and preferably ranges from 91% to 99%.

According to an implementation of the present disclosure, a cycling capacity retention rate of the battery after charge and discharge cycles at 25° C.±2° C. is 90% or above, and preferably ranges from 90% to 99%.

According to an implementation of the present disclosure, an EIS impedance value of the battery is less than or equal to 6 mΩ, and is preferably ranges from 0.1 mΩ to 6 mΩ.

The foregoing C-rate performance in the present disclosure is a ratio of a 10 C discharge capacity to a 0.33 C discharge capacity of the battery at 25° C.

The foregoing cycling capacity retention rate in the present disclosure is a ratio of a capacity tested after n cycles to a capacity tested after the first cycle of the battery at 25° C. or 45° C. under a 1 C charge condition and a 1 C discharge condition, where n ranges from 1500 to 5000.

According to an implementation of the present disclosure, a cycling capacity retention rate of the battery after 1500 charge and discharge cycles is above 90%.

Beneficial effects of the present disclosure are as follows.

Firstly, the positive electrode material of the present disclosure is a microsphere having a core-shell structure. The shell has an aggregated dense structure. The core has an aggregated loose structure (even its central position part is hollow). The special core-shell structure may relieve a stress load caused by particle expansion and contraction of the battery during charge and discharge, improving a C-rate performance and a cycling performance.

Secondly, the positive electrode active material of the present disclosure is a microsphere having a core-shell structure. A particle size of the particle is controllable. The shell of the positive electrode active material has an aggregated dense structure. The core of the positive electrode active material has an aggregated loose structure (even its central position part is hollow). This structure is beneficial to improving an infiltration effect of the electrolyte solution. Moreover, due to the inner loose structure, a diffusion distance of lithium ions is shortened, a diffusion path of the lithium ions is shortened, and various paths are provided for diffusion of the lithium ions. Therefore, the diffusion capability and the polarization effect of the lithium ions of the positive electrode material are improved obviously.

Thirdly, in the positive electrode material of the present disclosure, two elements are doped on the basis of lithium manganese iron phosphate, and an effective synergistic effect is formed between the two elements, so that an electronic conductivity and a lithium-ion diffusion rate of lithium manganese iron phosphate are improved obviously, and a battery having the positive electrode material has a good electrochemical performance. Doping of metal ions improves the electronic conductivity and ion diffusion rate of lithium manganese iron phosphate, and the synergistic effect of two-element doping may improve the capacity per gram for discharging and cycling performance of a lithium manganese iron phosphate positive electrode material. Compared with single-element doping or none doping, two-element doping can improve the electrochemical performance of lithium manganese iron phosphate from various aspects.

Fourthly, when the positive electrode material of the present disclosure is prepared into a positive electrode plate, and the positive electrode plate is used at a lithium-ion battery, an excellent cycling performance and a high output power performance are achieved. When the positive electrode material is used at a battery, the safety performance is relatively high.

Lastly, when the positive electrode material of the present disclosure is prepared into a positive electrode plate, and the positive electrode plate is used in a battery, the initial charge/discharge efficiency, coulombic efficiency, low-temperature performance, C-rate performance, and safety performance of a battery of the battery are improved obviously, resolving problems such as a low lithium-ion diffusion velocity and a polarization phenomenon of lithium manganese phosphate in the prior art, and obviously improving the safety performance and C-rate performance of the material.

The present disclosure further provides a preparation method of the foregoing positive electrode material. The positive electrode active material being lithium manganese phosphate is used as an example. The preparation method includes the following steps:
A1) separately preparing a precursor solution of a positive electrode active material, a complexing agent solution, a pH adjusting solution, and a reaction liquid;
A2) injecting the precursor solution of the positive electrode active material, the complexing agent solution, and the pH adjusting solution in step A1) into the reaction liquid for a first co-precipitation reaction, to obtain a solution containing a precursor crystal nucleus of the positive electrode active material;
A3) injecting the complexing agent solution and the pH adjusting solution in step A1) into the solution containing the precursor crystal nucleus of the positive electrode active material obtained in step A2) for a second co-precipitation reaction, and terminating the reaction after a target particle size is obtained in the reaction, to prepare an Mn₃(PO₄)₂ precursor of the positive electrode active material;
A4) evenly dispersing the Mn₃(PO₄)₂ precursor of the positive electrode active material obtained in step A3) into an Li₃PO₄ crystalloid solution for crystal nucleus growth, to obtain an LiMnPO₄ precursor; and
A5) mixing the LiMnPO₄ precursor obtained in step A4) with a carbon source, and performing high-temperature roasting in an inert atmosphere, to prepare and obtain the positive electrode material.

According to an implementation of the present disclosure, the precursor solution of the positive electrode active material in step A1) includes manganese ions (Mn²⁺) and phosphate ions (PO₄³⁻).

According to an implementation of the present disclosure, the manganese ions are provided by a manganese salt. Further preferably, the manganese salt is selected from at least one of (CH₃COO)₂Mn, MnSO₄, MnC₂O₄, or MnCl₂.

According to an implementation of the present disclosure, the phosphate ions are provided by a phosphate ion-containing water-soluble compound. Further, the phosphate ion-containing water-soluble compound is selected from a phosphoric acid or another soluble phosphate salt, and the soluble phosphate salt is selected from at least one of (NH₄)H₂PO₄, (NH₄)₂HPO₄, or (NH₄)₃PO₄.

According to an implementation of the present disclosure, a total molar concentration of the manganese ions (Mn²⁺) and the phosphate ions (PO₄³⁻) ranges from 1 mol/L to 3 mol/L, for example, is 1 mol/L, 2 mol/L, 3 mol/L, or a point value in a range formed by any two of the foregoing values.

According to an implementation of the present disclosure, a molar ratio of the phosphate ions (PO₄³⁻) to the manganese ions (Mn²⁺) ranges from 0.98:1 to 1.05:1, for example, is 0.98:1, 0.99:1, 1:1, 1.01:1, 1.02:1, 1.03:1, 1.04:1, 1.05:1, or a point value in a range formed by any two of the foregoing values.

According to an implementation of the present disclosure, the complexing agent solution in step A1) contains a complexing agent.

According to an implementation of the present disclosure, the complexing agent is selected from at least one of an oxalic acid, a citric acid, or EDTA.

According to an implementation of the present disclosure, a concentration of the complexing agent solution ranges from 1 mol/L to 3 mol/L, for example, is 1 mol/L, 2 mol/L, 3 mol/L, or a point value in a range formed by any two of the foregoing values.

According to an implementation of the present disclosure, the pH adjusting solution in step A1) includes an organic acid and/or an inorganic acid. For example, the organic acid is selected from an acetic acid or an oxalic acid. For example, the inorganic acid is selected from a carbonic acid.

According to an implementation of the present disclosure, a concentration of the pH adjusting solution ranges from 0.025 mol/L to 0.3 mol/L, for example, is 0.025 mol/L, 0.03 mol/L, 0.04 mol/L, 0.05 mol/L, 0.06 mol/L, 0.07 mol/L, 0.08 mol/L, 0.09 mol/L, 0.1 mol/L, 0.2 mol/L, 0.3 mol/L, or a point value in a range formed by any two of the foregoing values.

According to an implementation of the present disclosure, the reaction liquid in step A1) is a mixed solvent of an alcoholic solvent and water.

According to an implementation of the present disclosure, the alcoholic solvent is selected from at least one of ethylene glycol, glycerol, polyethylene glycol 400, or polyethylene glycol 200.

According to an implementation of the present disclosure, a volume ratio of the alcoholic solvent to water ranges from 1:1 to 5:1 for example, is 1:1, 2:1, 3:1, 4:1, 5:1, or a point value in a range formed by any two of the foregoing values, and preferably ranges from 2:1 to 3:1.

According to an implementation of the present disclosure, step A2) is a nucleation and kernel growth phase of the precursor of the positive electrode active material.

According to an implementation of the present disclosure, reaction conditions in step A2) and step A3) are controlled by adjusting and controlling addition amounts of the complexing agent solution and the pH adjusting solution in step A2) and step A3).

According to an implementation of the present disclosure, the reaction conditions in step A2) include: a pH value ranging from 1.5 to 2.4 (for example, is 1.5, 1.6, 1.7, 1.8, 1.9, 2, 2.1, 2.2, 2.3, 2.4, or a point value in a range formed by any two of the foregoing values), and a concentration of the complexing agent ranging from 0.02 mol/L to 0.05 mol/L (for example, is 0.02 mol/L, 0.03 mol/L, 0.04 mol/L, 0.05 mol/L, or a point value in a range formed by any two of the foregoing values). Under these conditions, the kernel region having the aggregated loose structure may be prepared.

According to an implementation of the present disclosure, in step A2), a time of the first co-precipitation reaction ranges from 8 hours to 20 hours (for example, is 8 hours, 9 hours, 10 hours, 11 hours, 12 hours, 13 hours, 14 hours, 15 hours, 16 hours, 17 hours, 18 hours, 19 hours, 20 hours, or a point value in a range formed by any two of the foregoing values); a temperature of the first co-precipitation reaction ranges from 50° C. to 75° C. (for example, is 50° C., 55° C., 60° C., 65° C., 70° C., 75° C., or a point value in a range formed by any two of the foregoing values); and an inert gas, for example, nitrogen gas, is continuously injected in a process of the first co-precipitation reaction.

According to an implementation of the present disclosure, step A3) is a shell production phase of the precursor of the positive electrode active material.

According to an implementation of the present disclosure, in step A3), a molecular formula of the precursor of the positive electrode active material is Mn₃(PO₄)₂.

According to an implementation of the present disclosure, the reaction conditions in step A3) include: a pH value ranging from 2.6 to 3.5 (for example, is 2.6, 2.7, 2.8, 2.9, 3, 3.1, 3.2, 3.3, 3.4, 3.5, or a point value in a range formed by any two of the foregoing values), and a concentration of the complexing agent ranging from 0.1 mol/L to 0.3 mol/L (for example, is 0.02 mol/L, 0.03 mol/L, 0.04 mol/L, 0.05 mol/L, or a point value in a range formed by any two of the foregoing values). Under these conditions, the shell region having the aggregated dense structure may be prepared.

According to an implementation of the present disclosure, in step A3), a time of the second co-precipitation reaction ranges from 48 hours to 96 hours (for example, is 48 hours, 50 hours, 55 hours, 60 hours, 65 hours, 70 hours, 75 hours, 80 hours, 85 hours, 90 hours, 95 hours, 96 hours, or a point value in a range formed by any two of the foregoing values); a temperature of the second co-precipitation reaction ranges from 50° C. to 75° C. (for example, is 50° C., 55° C., 60° C., 65° C., 70° C., 75° C., or a point value in a range formed by any two of the foregoing values); and an inert gas, for example, nitrogen gas, is continuously injected in a process of the second co-precipitation reaction.

According to an implementation of the present disclosure, the first co-precipitation reaction and the second co-precipitation reaction are both performed under stirring conditions. Preferably, a stirring rate in the first co-precipitation reaction is greater than a stirring rate in the second co-precipitation reaction. For example, the stirring rate in the first co-precipitation reaction ranges from 200 rpm to 650 rpm (for example, is 200 rpm, 250 rpm, 300 rpm, 350 rpm, 400 rpm, 450 rpm, 500 rpm, 550 rpm, 600 rpm, 650 rpm, or a point value in a range formed by any two of the foregoing values); and the stirring rate in the second co-precipitation reaction ranges from 150 rpm to 500 rpm (for example, is 150 rpm, 200 rpm, 250 rpm, 300 rpm, 350 rpm, 400 rpm, 450 rpm, 500 rpm, or a point value in a range formed by any two of the foregoing values).

According to an implementation of the present disclosure, the target particle size in step A3) is Dv50 controlled between 2 μm and 5 μm, for example, is 2 μm, 3 μm, 4 μm, 5 μm, or a point value in a range formed by any two of the foregoing values.

According to an implementation of the present disclosure, step A3) further includes: performing solid-liquid separation, aging, drying, grinding, sieving, and impurity removal on a slurry obtained after the reaction, to obtain the Mn₃(PO₄)₂ precursor of the positive electrode active material.

According to an implementation of the present disclosure, the Li₃PO₄ crystalloid solution in step A4) is prepared according to the following method:
adding a phosphoric acid solution into an LiOH solution for reaction, to obtain the Li₃PO₄ crystalloid solution.

The phosphoric acid solution is an aqueous phosphoric acid solution with a molar concentration ranging from 1 mol/L to 2.5 mol/L (for example, is 1 mol/L, 1.5 mol/L, 2 mol/L, 2.5 mol/L, or a point value in a range formed by any two of the foregoing values). The LiOH solution is an aqueous LiOH solution with a molar concentration ranging from 1 mol/L to 2.5 mol/L (for example, is 1 mol/L, 1.5 mol/L, 2 mol/L, 2.5 mol/L, or a point value in a range formed by any two of the foregoing values). A molar ratio of Li⁺ to PO₄³⁻ in the system ranges from 0.96:1 to 1.1:1 (for example, is 0.96:1, 1:1, 1.1:1, or a point value in a range formed by any two of the foregoing values).

According to an implementation of the present disclosure, the addition amounts of Li₃PO₄ and Mn₃(PO₄)₂ in step A4) meet the following condition: The molar ratio of Li⁺ to Mn²⁺ in the system ranges from 0.96:1 to 1.1:1, for example, is 0.96:1, 1:1, 1.1:1, or a point value in a range formed by any two of the foregoing values.

According to an implementation of the present disclosure, the carbon source in step A5) is selected from an organic carbon source and/or an inorganic carbon source. Preferably, the organic carbon source is selected from at least one of glucose, sucrose, lemon sugar, polyaniline, or a PEDOT conductive polymer. Preferably, the inorganic carbon source is selected from at least one of carbon nanotube, conductive graphene, or conductive carbon black.

According to an implementation of the present disclosure, the mixing in step A5) is, for example, at least one of stirring, ball-milling, or grinding.

According to an implementation of the present disclosure, the inert atmosphere in step A5) includes at least one of nitrogen gas, argon gas, or the like.

According to an implementation of the present disclosure, a mass ratio of the carbon source to the LiMnPO₄ precursor in step A5) ranges from 0.07:1 to 0.12:1, for example, is 0.07:1, 0.08:1, 0.09:1, 0.1:1, 0.11:1, 0.12:1, or a point value in a range formed by any two of the foregoing values.

According to an implementation of the present disclosure, roasting in step A5) includes multi-stage temperature-controlled sintering, and specifically includes the following steps: raising a temperature from a room temperature (for example, is 25° C.) to 500° C. to 600° C. (for example, is 500° C., 550° C., 600° C., or a point value in a range formed by any two of the foregoing values) at a heating rate of 3° C./min; keeping the raised temperature at 500° C. to 600° C. for 4 hours to 6 hours (for example, is 4 hours, 5 hours, 6 hours, or a point value in a range formed by any two of the foregoing values); then raising the temperature to 650° C. to 800° C. (for example, is 650° C., 700° C., 750° C., 800° C., or a point value in a range formed by any two of the foregoing values); and finally keeping the temperature for 8 hours to 12 hours (for example, is 8 hours, 9 hours, 10 hours, 11 hours, 12 hours, or a point value in a range formed by any two of the foregoing values), to obtain the positive electrode material.

According to an implementation of the present disclosure, in step A5), the carbon source is pyrolyzed at a high temperature into amorphous carbon; and the amorphous carbon is evenly deposited on a surface of the positive electrode active material.

The present disclosure provides a preparation method of a battery. The battery includes a positive electrode plate, a negative electrode plate, a commercialized battery separator, and an electrolyte solution. A commercialized battery is prepared according to a standardized operation, can be used at a soft-package battery or cylindrical battery level, and has a relatively high commercial value and practical significance.

The present disclosure further provides another preparation method of the foregoing positive electrode material. The positive electrode active material being LiₐFeₓMn_{1-x-y-z}M_{y}N_{z}PO₄ is used as an example, where 0≤x≤0.6, 0≤y≤0.02, and 0≤z≤0.02 (M and N are co-doping elements). The preparation method specifically includes the following steps:
B1) separately preparing a precursor ternary solution of a positive electrode active material, a complexing agent solution, and a pH adjusting solution, and a mixing solution that is optionally added or not added; preparing a reaction liquid; and performing stirring;
B2) nucleation and kernel growth phase of a precursor of the positive electrode active material: injecting the precursor ternary solution of the positive electrode active material, the complexing agent solution, and the pH adjusting solution in step B1) into the reaction liquid for a first co-precipitation reaction, to obtain a solution containing a precursor crystal nucleus of the positive electrode active material;
B3) shell production phase of the precursor of the positive electrode active material: injecting the complexing agent solution and the pH adjusting solution into the solution containing the precursor crystal nucleus of the positive electrode active material obtained in step B2), performing stirring for a second co-precipitation reaction, and terminating the reaction after a target particle size Dv50 is obtained in the reaction, to prepare the precursor of the positive electrode active material; and
B4) performing ball-milling mixing on the precursor of the positive electrode active material obtained in step B3), a phosphate salt, a lithium salt, and a carbon source, and performing high-temperature roasting in an inert atmosphere, to obtain the positive electrode material.

According to an implementation of the present disclosure, the precursor ternary solution of the positive electrode active material in step B1) includes ferrous ions (Fe²⁺), manganese ions (Mn²⁺), and phosphate ions (PO₄³⁻).

According to an implementation of the present disclosure, the ferrous ions are provided by a soluble ferrous salt. Further preferably, the soluble ferrous salt is selected from at least one of FeC₂O₄, FeSO₄, FeCl₂, or (CH₃COO)₂Fe.

According to an implementation of the present disclosure, the manganese ions are provided by a manganese salt. Further preferably, the manganese salt is selected from at least one of (CH₃COO)₂Mn, MnSO₄, MnC₂O₄, or MnCl₂.

According to an implementation of the present disclosure, the phosphate ions are provided by a phosphate ion-containing water-soluble compound. Further, the phosphate ion-containing water-soluble compound is selected from a phosphoric acid or another soluble phosphate salt, and the soluble phosphate salt is selected from at least one of (NH₄)H₂PO₄, (NH₄)₂HPO₄, or (NH₄)₃PO₄.

According to an implementation of the present disclosure, a molar ratio of a sum of the ferrous ions and the manganese ions (Fe²⁺+Mn²⁺) to the phosphate ions (PO₄³⁻) ranges from 2.85:2 to 3.15:2, for example, is 2.85:2, 2.9:2, 2.95:2, 3:2, 3.05:2, 3.1:2, 3.15:2, or a point value in a range formed by any two of the foregoing values.

According to an implementation of the present disclosure, a total molar concentration of the ferrous ions (Fe²⁺), the manganese ions (Mn²⁺), and the phosphate ions (PO₄³⁻) ranges from 1 mol/L to 3 mol/L, for example, is 1 mol/L, 2 mol/L, 3 mol/L, or a point value in a range formed by any two of the foregoing values.

According to an implementation of the present disclosure, the complexing agent solution contains a complexing agent.

According to an implementation of the present disclosure, the complexing agent is selected from at least one of an oxalic acid, a citric acid, or EDTA.

According to an implementation of the present disclosure, a concentration of the complexing agent ranges from 1 mol/L to 3 mol/L, for example, is 1 mol/L, 2 mol/L, 3 mol/L, or a point value in a range formed by any two of the foregoing values.

According to an implementation of the present disclosure, the pH adjusting solution includes an organic acid and/or an inorganic acid. For example, the organic acid is selected from an acetic acid or an oxalic acid. For example, the inorganic acid is selected from a carbonic acid.

According to an implementation of the present disclosure, a concentration of the pH adjusting solution ranges from 0.05 mol/L to 0.25 mol/L, for example, is 0.05 mol/L, 0.1 mol/L, 0.15 mol/L, 0.2 mol/L, 0.25 mol/L, or a point value in a range formed by any two of the foregoing values.

According to an implementation of the present disclosure, the mixing solution contains vanadium ions and niobium ions.

Preferably, the vanadium ions are provided by a vanadium salt. For example, the vanadium salt is selected from a sulfate or a chloride of vanadium.

Preferably, the niobium ions are provided by a niobium salt. For example, the niobium salt is selected from a sulfate or a chloride of niobium.

Preferably, in the mixing solution, a molar ratio of the vanadium ions to the niobium ions ranges from 0.5:1 to 2:1, for example, is 0.5:1, 1:1, 1.5:1, 2:1, or a point value in a range formed by any two of the foregoing values.

Preferably, a concentration of the mixing solution ranges from 0.01 mol/L to 0.05 mol/L, for example, is 0.01 mol/L, 0.02 mol/L, 0.03 mol/L, 0.04 mol/L, 0.05 mol/L, or a point value in a range formed by any two of the foregoing values.

According to an implementation of the present disclosure, the reaction liquid in step B1) is a mixed solvent of an alcoholic solvent and water.

According to an implementation of the present disclosure, the alcoholic solvent is selected from at least one of ethylene glycol, glycerol, polyethylene glycol 400, or polyethylene glycol 200.

According to an implementation of the present disclosure, a volume ratio of the alcoholic solvent to water ranges from 1:1 to 5:1 (for example, is 1:1, 2:1, 3:1, 4:1, 5:1, or a point value in a range formed by any two of the foregoing values), and preferably ranges from 2:1 to 3:1.

According to an implementation of the present disclosure, a particle size Dv50 of the crystal nucleus in step B2) ranges from 1 μm to 2.8 μm, for example, is 1 μm, 1.5 μm, 2 μm, 2.5 m, 2.8 μm, or a point value in a range formed by any two of the foregoing values.

According to an implementation of the present disclosure, a molar ratio of (Fe²⁺+Mn²⁺) to (V⁵⁺+Nb⁵⁺) in step B2) is (99.1 to 99.9) to (0.1 to 0.9), for example, is 99.5:0.5 or 99.6:0.4.

According to an implementation of the present disclosure, in step B2) and step B3), reaction temperatures range from 50° C. to 70° C. (for example, is 50° C., 60° C., 70° C., or a point value in a range formed by any two of the foregoing values); and an inert gas, for example, nitrogen gas, is continuously injected in processes of the reactions. In the present disclosure, reaction conditions in step B2) and step B3) are controlled by adjusting and controlling addition amounts of the complexing agent solution and the pH adjusting solution.

According to an implementation of the present disclosure, the reaction conditions in step B2) include: a pH value ranging from 1.5 to 2.4 (for example, is 1.5, 1.6, 1.7, 1.8, 1.9, 2, 2.1, 2.2, 2.3, 2.4, or a point value in a range formed by any two of the foregoing values), and a concentration of the complexing agent ranging from 0.02 mol/L to 0.05 mol/L (for example, is 0.02 mol/L, 0.03 mol/L, 0.04 mol/L, 0.05 mol/L, or a point value in a range formed by any two of the foregoing values).

According to an implementation of the present disclosure, a time of the first co-precipitation reaction in step B2) ranges from 8 hours to 20 hours, for example, is 8 hours, 9 hours, 10 hours, 11 hours, 12 hours, 13 hours, 14 hours, 15 hours, 16 hours, 17 hours, 18 hours, 19 hours, 20 hours, or a point value in a range formed by any two of the foregoing values.

According to an implementation of the present disclosure, the reaction conditions in step B3) include: a pH value ranging from 2.6 to 3.5 (for example, is 2.6, 2.7, 2.8, 2.9, 3, 3.1, 3.2, 3.3, 3.4, 3.5, or a point value in a range formed by any two of the foregoing values), and a concentration of the complexing agent ranging from 0.1 mol/L to 0.25 mol/L (for example, is 0.1 mol/L, 0.15 mol/L, 0.2 mol/L, 0.25 mol/L, or a point value in a range formed by any two of the foregoing values).

According to an implementation of the present disclosure, a time of the second co-precipitation reaction in step B3) ranges from 48 hours to 96 hours, for example, is 48 hours, 50 hours, 55 hours, 60 hours, 65 hours, 70 hours, 75 hours, 80 hours, 86 hours, 90 hours, 95 hours, 96 hours, or a point value in a range formed by any two of the foregoing values.

According to an implementation of the present disclosure, the first co-precipitation reaction and the second co-precipitation reaction are both performed under stirring conditions.

Preferably, a stirring rate in the first co-precipitation reaction is greater than a stirring rate in the second co-precipitation reaction. For example, the stirring rate in the first co-precipitation reaction ranges from 200 rpm to 650 rpm (for example, is 200 rpm, 250 rpm, 300 rpm, 350 rpm, 400 rpm, 450 rpm, 500 rpm, 550 rpm, 600 rpm, 650 rpm, or a point value in a range formed by any two of the foregoing values); and the stirring rate in the second co-precipitation reaction ranges from 150 rpm to 500 rpm (for example, is 150 rpm, 200 rpm, 250 rpm, 300 rpm, 350 rpm, 400 rpm, 450 rpm, 500 rpm, or a point value in a range formed by any two of the foregoing values).

According to an implementation of the present disclosure, the target particle size in step B3) is a particle size Dv50 controlled between 3 μm and 7 μm, for example, is 3 μm, 4 μm, 5 μm, 6 μm, 7 μm, or a point value in a range formed by any two of the foregoing values.

According to an implementation of the present disclosure, in step B3), the positive electrode active precursor is obtained by performing solid-liquid separation, aging, drying, grinding, sieving, and impurity removal on a slurry obtained after the reaction.

According to an implementation of the present disclosure, in step B3), a kernel region of the positive electrode active precursor is composed of loosely aggregated tiny particles formed by the crystal nucleus in step B2); a shell region on a surface layer is composed of densely aggregated large particles; and a component of the particles in the kernel region is consistent with that of the particles in the shell region.

According to an implementation of the present disclosure, in step B4), a molar ratio of the lithium ions (Li⁺) in the lithium salt to a sum of the ferrous ions, the manganese ions, and the optional vanadium ions and niobium ions ranges from 0.96:1 to 1.1:1, for example, is 0.96:1, 0.97:1, 0.98:1, 0.99:1, 1:1, 1.05:1, 1.1:1, or a point value in a range formed by any two of the foregoing values.

According to an implementation of the present disclosure, the lithium salt is selected from at least one of lithium carbonate, lithium hydroxide, lithium oxalate, or lithium acetate.

According to an implementation of the present disclosure, in step B4), a molar ratio of the phosphate ions (PO₄³⁻) in the phosphate to a sum of the ferrous ions, the manganese ions, and the optional vanadium ions and niobium ions ranges from 0.95:1 to 1.1:1, for example, is 0.95:1, 0.96:1, 0.97:1, 0.98:1, 0.99:1, 1:1, 1.05:1, 1.1:1, or a point value in a range formed by any two of the foregoing values. Preferably, the phosphate is selected from at least one of the foregoing phosphate ion-containing water-soluble compound.

According to an implementation of the present disclosure, the carbon source in step B4) is selected from an organic carbon source and/or an inorganic carbon source. Preferably, the organic carbon source is selected from at least one of glucose, sucrose, lemon sugar, polyaniline, or a PEDOT conductive polymer.

According to an implementation of the present disclosure, a mass ratio of the carbon source to the precursor of the positive electrode active material in step B4) ranges from 0.07:1 to 0.1:1, for example, is 0.07:1, 0.08:1, 0.09:1, 0.1:1, or a point value in a range formed by any two of the foregoing values.

According to an implementation of the present disclosure, roasting in step B4) includes multi-stage temperature-controlled sintering, and specifically includes the following steps: raising a temperature from a room temperature to 500° C. to 600° C. (for example, is 500° C., 550° C., 600° C., or a point value in a range formed by any two of the foregoing values) at a heating rate of 3° C./min; keeping the raised temperature at 500° C. to 600° C. for 4 hours to 6 hours (for example, is 4 hours, 5 hours, 6 hours, or a point value in a range formed by any two of the foregoing values); then raising the temperature to 650° C. to 800° C. (for example, is 650° C., 700° C., 750° C., 800° C., or a point value in a range formed by any two of the foregoing values); and finally keeping the temperature for 8 hours to 12 hours (for example, is 8 hours, 9 hours, 10 hours, 11 hours, 12 hours, or a point value in a range formed by any two of the foregoing values), to obtain the positive electrode material. The carbon source is pyrolyzed at a high temperature into amorphous carbon; and the amorphous carbon is evenly deposited on a surface of the positive electrode active material.

The preparation method of a positive electrode material provided in the present disclosure has the following beneficial effects.

Firstly, according to the present disclosure, a conventional co-precipitation method is optimized, to prepare and obtain a precursor having a core-shell structure, where a structure of an inner primary particle of the core-shell structure is different from a structure of an outer primary particle of the core-shell structure. This provides a new idea for preparation of a positive electrode material having a special core-shell structure. The positive electrode material of the present disclosure can overcome deficiencies and defects of a high impedance and a relatively low cycling performance of a lithium manganese iron phosphate positive electrode material prepared according to a conventional synthesis method, and has a relatively good electrochemical performance in application to a battery.

Lastly, according to the present disclosure, no pore forming agent or template agent needs to be added in a preparation process. A positive electrode material having a specific particle size and further having a special core-shell structure is prepared according to an optimized synthesis method. The positive electrode material has a relatively high capacity per gram for discharging, low costs, a relatively high product purity, and a simple technology; and production of an industrialized grade can be implemented.

The present disclosure is further described in detail below with reference to specific examples. It should be understood that the following examples are merely for the purposes of illustrating and explaining the present disclosure, and should not be construed as limiting the protection scope of the present disclosure. All technologies achieved based on the foregoing content of the present disclosure are included in the protection scope of the present disclosure.

Experimental methods used in the following examples are all conventional methods, unless otherwise specified. Reagents, materials, and the like used in the following examples are all commercially available, unless otherwise specified.

### Examples 1 to 4 and Comparative Example 1

### Example 1

### I. Preparation of a Positive Electrode Material

(1) A binary solution, an oxalic acid solution, and an acetic acid solution were separately prepared for standby use, where the binary solution included MnSO₄ and H₃PO₄, a molar concentration of the binary solution was 1.5 mol/L, and a molar ratio of PO₄³⁻ to Mn²⁺ in the system was 1.02:1. A reaction liquid was prepared, and stirring was performed, where the reaction liquid was a mixed solvent obtained by mixing glycerol and water at a volume ratio of 2:1, a concentration of the oxalic acid solution was 1.25 mol/L, and a concentration of the acetic acid solution was 0.15 mol/L.
(2) The binary solution, the oxalic acid solution, and the acetic acid solution were injected into the reaction liquid to obtain a mixed solution. A phase-1 reaction and a phase-2 reaction were performed, where reaction temperatures were adjusted and controlled to be 65° C., and nitrogen gas was continuously injected in the reaction processes.

Phase 1: The foregoing mixed solution was injected to a reactor. Stirring was performed to form an intermediate reaction liquid, where a rotational speed was controlled to be 400 rpm, a concentration of the oxalic acid solution was controlled to be 0.03 mol/L, and a pH value of the mixed solution was adjusted and controlled to be 2.2. A co-precipitation reaction in Phase 1 was performed for 12 hours to obtain a precursor crystal nucleus, where this process was a nucleation and kernel growth phase of a precursor.

Phase 2: The oxalic acid solution and the acetic acid solution were injected into a solution of the precursor crystal nucleus obtained in the foregoing step, where a pH value of the system was adjusted to 3.0, and a concentration of a complexing agent was adjusted and controlled to be 0.2 mol/L. A co-precipitation reaction was performed at a stirring rate of 350 rpm, where this phase was a shell production phase of the precursor. The reaction was terminated after a target particle size reached 3.5 μm, to obtain a precursor Mn₃(PO₄)₂, where a kernel region of the precursor was composed of loosely aggregated tiny particles, a shell region of the precursor was composed of densely aggregated large particles, and both components of the particles of the kernel region and the shell region were Mn₃(PO₄)₂.
(3) Solid-liquid separation, aging, drying, grinding, sieving, and impurity removal were performed on a slurry obtained after the reaction, to obtain the precursor Mn₃(PO₄)₂.
(4) A phosphoric acid solution was added into an LiOH solution for reaction, to obtain an Li₃PO₄ crystalloid solution, where the phosphoric acid solution was an aqueous phosphoric acid solution with a molar concentration of 1.25 mol/L, the LiOH solution was an aqueous LiOH solution with a molar concentration of 1.5 mol/L, and a molar ratio of Li⁺ to PO₄³⁻ in the system was 1.02:1. The precursor Mn₃(PO₄)₂ was evenly dispersed into the Li₃PO₄ crystalloid solution for crystal nucleus growth, where a time of a crystal nucleus reaction was 8 hours, and a precursor LiMnPO₄ was obtained after the reaction ends. Li₃PO₄ and Mn₃(PO₄)₂ were weighed, where a molar ratio of Li⁺ to Mn²⁺ was 1.04:1.
(5) Glucose and the precursor LiMnPO₄ were mixed at a mass ratio of 0.10:1. High-temperature roasting was performed in an inert atmosphere, where a multi-stage temperature-controlled sintering manner was used in a sintering process, a temperature was raised from a room temperature to 580° C. at a heating rate of 3° C./min, heat preservation was first performed at 580° C. for 4 hours, then the temperature was raised to 700° C., and heat preservation was performed again for 8 hours. A sample was naturally cooled to the room temperature, to obtain lithium manganese phosphate having a carbon-coated structure and denoted as LiMnPO₄/C, where a carbon content tested with a carbon-sulfur detector was 2.2% (mass ratio), and a specific surface area (BET value) is shown in Table 1.

A particle size Dv50 of the positive electrode material was 3.8 μm. It may be learned by using a porosity tester that porosities of the kernel region and the shell region were 75% and 26%, respectively.

FIG. 2 is an XRD spectrum of the lithium manganese phosphate positive electrode material in Example 1. It may be learned that a standard lithium manganese phosphate material was prepared in Example 1. A PDF card matching result was good.

FIG. 3 is an SEM image of a section of the positive electrode material in Example 1. It may be learned that the kernel region of the positive electrode material in Example 1 was composed of loosely aggregated tiny particles, that the shell region thereof was composed of densely aggregated large particles, and that the kernel region had a loose structure, and partially had a hollow structure.

II. Assembly of a button battery: The positive electrode material prepared above, a conductive agent acetylene black, and a binder PVDF were weighed at a mass ratio of 94:3:3 and evenly mixed. An N-methylpyrrolidone (NMP) solvent was dispersed to form a slurry. The slurry was evenly applied on aluminum foil and dried at 80° C. for 12 hours. An electrode plate obtained after drying was cut into a wafer. The wafer was placed in a glove box for standby use. A 2032-type button battery was assembled by using the electrode plate prepared above as a positive electrode plate, using lithium metal as a negative electrode, using Celgard 2400 (micropore polypropylene film) as a separator, and using 1 mol/L of LiPF₆ (EC:DMC:DMC=1:1:1) as an electrolyte solution. Assembly of the button battery should be performed in a glove box in which argon gas is used as protective gas.

### III. Production of a Soft-Package Battery

### (1) Preparation of a Positive Electrode Plate

The positive electrode material prepared above, a binder PVDF, and conductive agents acetylene black and carbon nanotube were mixed at a weight ratio of 96.5:1.5:1.5:0.5. N-methylpyrrolidone (NMP) was added. Stirring was performed under action of a vacuum mixer until a mixed system became a positive electrode slurry with uniform fluidity, where a solid content of the positive electrode slurry ranged from 54% to 58%, and a viscosity of the positive electrode slurry was controlled to range from 2500 mPa·s to 4500 mPa·s. The positive electrode slurry was evenly applied on carbon-coated aluminum foil having a thickness of (10+2) m, where a surface density was controlled to range from 15 mg/cm² to 18 mg/cm². The coated aluminum foil was baked in a five-stage oven with different temperatures, followed by roll-pressing and cutting, to obtain the required positive electrode plate.

### (2) Preparation of a Negative Electrode Plate

A negative electrode active material graphite, a thickener sodium carboxymethyl cellulose (CMC-Na), a binder styrene-butadiene rubber, and a conductive agent acetylene black were mixed at a weight ratio of 97:1.2:1.2:0.6, and added into deionized water. The mixture was stirred under action of a vacuum mixer to obtain a negative electrode slurry. The negative electrode slurry was evenly applied on copper foil having a thickness of 8 μm. The coated copper foil was baked in a three-stage oven with different temperatures, followed by twice roll-pressing and cutting, to obtain the required negative electrode plate.

### (3) Preparation of an Electrolyte Solution

Ethylene carbonate, propylene carbonate, and diethyl carbonate were evenly mixed at a mass ratio of 1:1:1 in a glove box filled with argon gas and with a qualified water content and oxygen content (a solvent and an additive should be normalized together), and then quickly added with 1 mol/L of fully dried lithium hexafluorophosphate (LiPF₆). The mixture was evenly stirred. The required electrolyte solution was obtained after passing water content and free acid tests.

### (4) Preparation of a Separator

A 7 μm+3 μm separator with a mixed coating (a substrate polypropylene film+a PVDF & ceramics mixed coating) (from AsahiKASEI Corporation) was used.

### (5) Preparation of a Lithium-Ion Battery

The positive electrode plate, the separator, and the negative electrode plate prepared above were sequentially stacked, where the negative electrode plate was wrapped with two separators, to ensure that the separators were located between the positive electrode plate and the negative electrode plate for separation. Then, winding was performed to obtain an unfilled bare cell. The bare cell was placed in outer packaging foil. The electrolyte solution prepared above was injected into the dried bare cell. After processes such as vacuum packaging, standing, forming, shaping, and sorting, the required soft-package battery was obtained.

### Example 2

### I. Preparation of a Positive Electrode Material

(1) A binary solution, an EDTA solution, and an oxalic acid solution were separately prepared for standby use, where the binary solution included MnCl₂ and H₃PO₄, a molar concentration of the binary solution was 1.25 mol/L, and a molar ratio of PO₄³⁻ to Mn²⁺ in the system was 0.98:1. A reaction liquid was prepared, and stirring was performed, where the reaction liquid was a mixed solvent obtained by mixing ethylene glycol and water at a volume ratio of 2:1, a concentration of the EDTA solution was 1.25 mol/L, and a concentration of the oxalic acid solution was 0.15 mol/L.
(2) The binary solution, the EDTA solution, and the oxalic acid solution were injected into the reaction liquid to obtain a mixed solution. A phase-1 reaction and a phase-2 reaction were performed, where reaction temperatures were adjusted and controlled to be 60° C., and nitrogen gas was continuously injected in the reaction processes.

Phase 1: The foregoing mixed solution was injected to a reactor. Stirring was performed to form an intermediate reaction liquid, where a rotational speed was controlled to be 420 rpm, a concentration of the EDTA solution was controlled to be 0.05 mol/L, and a pH value of the mixed solution was adjusted and controlled to be 2.0. A co-precipitation reaction in Phase 1 was performed for 10 hours to obtain a precursor crystal nucleus, where this process was a nucleation and kernel growth phase of a precursor.

Phase 2: The EDTA solution and the oxalic acid solution were injected into a solution of the precursor crystal nucleus obtained in the foregoing step, where a pH value of the system was adjusted to 3.0, and a concentration of a complexing agent was adjusted and controlled to be 0.25 mol/L. A co-precipitation reaction was performed at a stirring rate of 360 rpm, where this phase was a shell production phase of the precursor. The reaction was terminated after a target particle size reached 3.0 μm, to obtain a precursor Mn₃(PO₄)₂, where a kernel region of the precursor was composed of loosely aggregated tiny particles, a shell region of the precursor was composed of densely aggregated large particles, and both components of the particles of the kernel region and the shell region were Mn₃(PO₄)₂.
(3) Solid-liquid separation, aging, drying, grinding, sieving, and impurity removal were performed on a slurry obtained after the reaction, to obtain the precursor Mn₃(PO₄)₂.
(4) A phosphoric acid solution was added into an LiOH solution for reaction, to obtain an Li₃PO₄ crystalloid solution, where the phosphoric acid solution was an aqueous phosphoric acid solution with a molar concentration of 1.0 mol/L, the LiOH solution was an aqueous LiOH solution with a molar concentration of 1.25 mol/L, and a molar ratio of Li⁺ to PO₄³⁻ in the system was 1.05:1. The precursor Mn₃(PO₄)₂ was evenly dispersed into the Li₃PO₄ crystalloid solution for crystal nucleus growth, where a time of a crystal nucleus reaction was 9 hours, and a precursor LiMnPO₄ was obtained after the reaction ends. Li₃PO₄ and Mn₃(PO₄)₂ were weighed, where a molar ratio of Li⁺ to Mn²⁺ was 1.02:1.
(5) A conductive polymer PEDOT and the precursor LiMnPO₄ were mixed at a mass ratio of 0.09:1. High-temperature roasting was performed in an inert atmosphere, where a multi-stage temperature-controlled sintering manner was used in a sintering process, a temperature was raised from a room temperature to 560° C. at a heating rate of 3° C./min, heat preservation was first performed at 560° C. for 5 hours, then the temperature was raised to 680° C., and heat preservation was performed again for 10 hours. A sample was naturally cooled to the room temperature, to obtain lithium manganese phosphate having a carbon-coated structure and denoted as LiMnPO₄/C, where a carbon content tested with a carbon-sulfur detector was 1.8% (mass ratio), and a specific surface area (BET value) is shown in Table 1.

A particle size Dv50 of the positive electrode material was 3.2 μm. It may be learned by using a porosity tester that porosities of the kernel region and the shell region were 80% and 28%, respectively.

II. Assembly of a button battery: Steps are the same as those in Example 1.

III. Production of a soft-package battery: Steps are the same as those in Example 1.

### Example 3

### I. Preparation of a Positive Electrode Material

(1) A binary solution, a citric acid solution, and a carbonic acid solution were separately prepared for standby use, where the binary solution included MnC₂O₄ and (NH₄)H₂PO₄, a molar concentration of the binary solution was 1.5 mol/L, and a molar ratio of PO₄³⁻ to Mn²⁺ in the system was 1.05:1. A reaction liquid was prepared, and stirring was performed, where the reaction liquid was a mixed solvent obtained by mixing polyethylene glycol 200 and water at a volume ratio of 1:1, a concentration of the citric acid solution was 2.0 mol/L, and a concentration of the carbonic acid solution was 0.1 mol/L.
(2) The binary solution, the citric acid solution, and the carbonic acid solution were injected into the reaction liquid to obtain a mixed solution. A phase-1 reaction and a phase-2 reaction were performed, where reaction temperatures were adjusted and controlled to be 55° C., and nitrogen gas was continuously injected in the reaction processes.

Phase 1: The foregoing mixed solution was injected to a reactor. Stirring was performed to form an intermediate reaction liquid, where a rotational speed was controlled to be 550 rpm, a concentration of the citric acid solution was controlled to be 0.04 mol/L, and a pH value of the mixed solution was adjusted and controlled to be 1.6. A co-precipitation reaction in Phase 1 was performed for 15 hours to obtain a precursor crystal nucleus, where this process was a nucleation and kernel growth phase of a precursor.

Phase 2: The citric acid solution and the carbonic acid solution were injected into a solution of the precursor crystal nucleus obtained in the foregoing step, where a pH value of the system was adjusted to 2.8, and a concentration of a complexing agent was adjusted and controlled to be 0.3 mol/L. A co-precipitation reaction was performed at a stirring rate of 420 rpm, where this phase was a shell production phase of the precursor. The reaction was terminated after a target particle size reached 3.8 μm, to obtain a precursor Mn₃(PO₄)₂, where a kernel region of the precursor was composed of loosely aggregated tiny particles, a shell region of the precursor was composed of densely aggregated large particles, and both components of the particles of the kernel region and the shell region were Mn₃(PO₄)₂.
(3) Solid-liquid separation, aging, drying, grinding, sieving, and impurity removal were performed on a slurry obtained after the reaction, to obtain the precursor Mn₃(PO₄)₂.
(4) A phosphoric acid solution was added into an LiOH solution for reaction, to obtain an Li₃PO₄ crystalloid solution, where the phosphoric acid solution was an aqueous phosphoric acid solution with a molar concentration of 1.5 mol/L, the LiOH solution was an aqueous LiOH solution with a molar concentration of 1.75 mol/L, and a molar ratio of Li⁺ to PO₄³⁻ in the system was 0.98:1. The precursor Mn₃(PO₄)₂ was evenly dispersed into the Li₃PO₄ crystalloid solution for crystal nucleus growth, where a time of a crystal nucleus reaction was 6 hours, and a precursor LiMnPO₄ was obtained after the reaction ends. Li₃PO₄ and Mn₃(PO₄)₂ were weighed, where a molar ratio of Li⁺ to Mn²⁺ was 1.04:1.
(5) Sucrose and the precursor LiMnPO₄ were mixed at a mass ratio of 0.08:1. High-temperature roasting was performed in an inert atmosphere, where a multi-stage temperature-controlled sintering manner was used in a sintering process, a temperature was raised from a room temperature to 600° C. at a heating rate of 3° C./min, heat preservation was first performed at 600° C. for 5 hours, then the temperature was raised to 750° C., and heat preservation was performed again for 10 hours. A sample was naturally cooled to the room temperature, to obtain lithium manganese phosphate having a carbon-coated structure and denoted as LiMnPO₄/C, where a carbon content tested with a carbon-sulfur detector was 1.6% (mass ratio), and a specific surface area (BET value) is shown in Table 1.

A particle size Dv50 of the positive electrode material was 4.0 μm. It may be learned by using a porosity tester that porosities of the kernel region and the shell region were 82% and 31%, respectively.

II. Assembly of a button battery: Steps are the same as those in Example 1.

III. Production of a soft-package battery: Steps are the same as those in Example 1.

### Example 4

(1) A binary solution, an EDTA solution, and an acetic acid solution were separately prepared for standby use, where the binary solution included (CH₃COO)₂Mn and (NH₄)₂HPO₄, a molar concentration of the binary solution was 2.5 mol/L, and a molar ratio of PO₄³⁻ to Mn²⁺ in the system was 1:1. A reaction liquid was prepared, and stirring was performed, where the reaction liquid was a mixed solvent obtained by mixing polyethylene glycol 400 and water at a volume ratio of 1:1, a concentration of the EDTA solution was 1.8 mol/L, and a concentration of the acetic acid solution was 0.2 mol/L.
(2) The binary solution, the EDTA solution, and the acetic acid solution were injected into the reaction liquid to obtain a mixed solution. A phase-1 reaction and a phase-2 reaction were performed, where reaction temperatures were adjusted and controlled to be 65° C., and nitrogen gas was continuously injected in the reaction processes.

Phase 1: The foregoing mixed solution was injected to a reactor. Stirring was performed to form an intermediate reaction liquid, where a rotational speed was controlled to be 500 rpm, a concentration of the EDTA solution was controlled to be 0.04 mol/L, and a pH value of the mixed solution was adjusted and controlled to be 2.0. A co-precipitation reaction in Phase 1 was performed for 10 hours to obtain a precursor crystal nucleus, where this process was a nucleation and kernel growth phase of a precursor.

Phase 2: The EDTA solution and the acetic acid solution were injected into a solution of the precursor crystal nucleus obtained in the foregoing step, where a pH value of the system was adjusted to 3.0, and a concentration of a complexing agent was adjusted and controlled to be 0.25 mol/L. A co-precipitation reaction was performed at a stirring rate of 450 rpm, where this phase was a shell production phase of the precursor. The reaction was terminated after a target particle size reached 3.2 μm, to obtain a precursor Mn₃(PO₄)₂, where a kernel region of the precursor was composed of loosely aggregated tiny particles, a shell region of the precursor was composed of densely aggregated large particles, and both components of the particles of the kernel region and the shell region were Mn₃(PO₄)₂.
(3) Solid-liquid separation, aging, drying, grinding, sieving, and impurity removal were performed on a slurry obtained after the reaction, to obtain the precursor Mn₃(PO₄)₂.
(4) A phosphoric acid solution was added into an LiOH solution for reaction, to obtain an Li₃PO₄ crystalloid solution, where the phosphoric acid solution was an aqueous phosphoric acid solution with a molar concentration of 1.25 mol/L, the LiOH solution was an aqueous LiOH solution with a molar concentration of 2.0 mol/L, and a molar ratio of Li⁺ to PO₄³⁻ in the system was 1:1. The precursor Mn₃(PO₄)₂ was evenly dispersed into the Li₃PO₄ crystalloid solution for crystal nucleus growth, where a time of a crystal nucleus reaction was 8 hours, and a precursor LiMnPO₄ was obtained after the reaction ends. Li₃PO₄ and Mn₃(PO₄)₂ were weighed, where a molar ratio of Li⁺ to Mn²⁺ was 1.02:1.
(5) Glucose and the precursor LiMnPO₄ were mixed at a mass ratio of 0.12:1. High-temperature roasting was performed in an inert atmosphere, where a multi-stage temperature-controlled sintering manner was used in a sintering process, a temperature was raised from a room temperature to 580° C. at a heating rate of 3° C./min, heat preservation was first performed at 580° C. for 6 hours, then the temperature was raised to 720° C., and heat preservation was performed again for 10 hours. A sample was naturally cooled to the room temperature, to obtain lithium manganese phosphate having a carbon-coated structure and denoted as LiMnPO₄/C, where a carbon content tested with a carbon-sulfur detector was 2.0% (mass ratio), and a specific surface area (BET value) is shown in Table 1.

A particle size Dv50 of the positive electrode material was 3.4 μm. It may be learned by using a porosity tester that porosities of the kernel region and the shell region were 76% and 25%, respectively.

II. Assembly of a button battery: Steps are the same as those in Example 1.

III. Production of a soft-package battery: Steps are the same as those in Example 1.

### Comparative Example 1

### I. Preparation of a Positive Electrode Material

(1) A binary solution, a citric acid solution, and an oxalic acid solution were separately prepared for standby use, where the binary solution included MnC₂O₄ and H₃PO₄, a molar concentration of the binary solution was 1.2 mol/L, and a molar ratio of PO₄³⁻ to Mn²⁺ in the system was 1.02:1. A reaction liquid was prepared, and stirring was performed, where the reaction liquid was a mixed solvent obtained by mixing ethylene glycol and water at a volume ratio of 3:1, a concentration of the citric acid solution was 2.0 mol/L, and a concentration of the oxalic acid solution was 0.15 mol/L.
(2) The binary solution, the citric acid solution, and the oxalic acid solution were injected into the reaction liquid to obtain a mixed solution. A co-precipitation reaction was performed, where a reaction temperature was adjusted and controlled to be 70° C., and nitrogen gas was continuously injected in the reaction process.

The foregoing mixed solution was injected into a reactor. An addition amount of the oxalic acid solution was finely adjusted to adjust a pH value of the system to 2.2, where a concentration of a complexing agent was adjusted and controlled to be 0.12 mol/L. A co-precipitation reaction was performed at a stirring rate of 450 rpm. The reaction was terminated after a target particle size reached 4.5 μm, to obtain a precursor Mn₃(PO₄)₂.
(3) Solid-liquid separation, aging, drying, grinding, sieving, and impurity removal were performed on a slurry obtained after the reaction, to obtain the precursor Mn₃(PO₄)₂.
(4) A phosphoric acid solution was added into an LiOH solution for reaction, to obtain an Li₃PO₄ crystalloid solution, where the phosphoric acid solution was an aqueous phosphoric acid solution with a molar concentration of 1.0 mol/L, the LiOH solution was an aqueous LiOH solution with a molar concentration of 1.5 mol/L, and a molar ratio of Li⁺ to PO₄³⁻ in the system was 1.02:1. The precursor Mn₃(PO₄)₂ was evenly dispersed into the Li₃PO₄ crystalloid solution for crystal nucleus growth, where a time of a crystal nucleus reaction was 10 hours, and a precursor LiMnPO₄ was obtained after the reaction ends. Li₃PO₄ and Mn₃(PO₄)₂ were weighed, where a molar ratio of Li⁺ to Mn²⁺ was 1.05:1.
(5) Glucose and the precursor LiMnPO₄ were mixed at a mass ratio of 0.1:1. High-temperature roasting was performed in an inert atmosphere, where a multi-stage temperature-controlled sintering manner was used in a sintering process, a temperature was raised from a room temperature to 550° C. at a heating rate of 3° C./min, heat preservation was first performed at 550° C. for 4 hours, then the temperature was raised to 660° C., and heat preservation was performed again for 10 hours. A sample was naturally cooled to the room temperature, to obtain lithium manganese phosphate having a carbon-coated structure and denoted as LiMnPO₄/C, where a carbon content tested with a carbon-sulfur detector was 1.8% (mass ratio), and a specific surface area (BET value) is shown in Table 1.

A particle size Dv50 of the positive electrode material was 4.6 μm. It may be learned by using a porosity tester that a porosity of the positive electrode active material LiMnPO₄ was 28%.

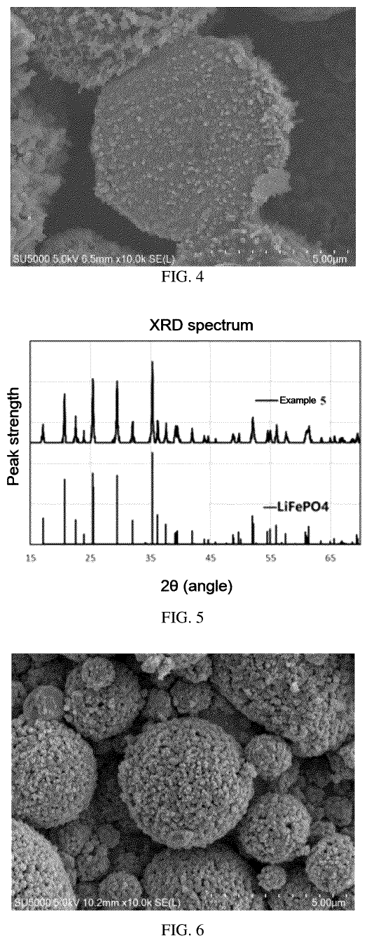

FIG. 4 is an SEM image of a section of the positive electrode material in Comparative Example 1. It may be learned that the positive electrode material prepared in Comparative Example 1 has a secondary spherical structure formed by tightly stacking primary particles, is a solid spherical particle, and does not have a hollow or aggregated loose structure. Compared with the aggregated loose structure prepared in Example 1, the positive electrode material in Comparative Example 1 has a lower porosity. Small particles on a surface in FIG. 4 are caused by vacuumizing in a shooting process of an electron microscope.

II. Assembly of a button battery: Steps are the same as those in Example 1.

III. Production of a soft-package battery: Steps are the same as those in Example 1.

### Examples 5 to 12 and Comparative Example 2

### Example 5

### I. Preparation of a Positive Electrode Material

(1) A ternary solution, an oxalic acid solution, and an acetic acid solution were separately prepared for standby use, where the ternary solution included FeSO₄, MnSO₄, and H₃PO₄, a total molar concentration of the ternary solution was 1.5 mol/L, a molar ratio of Fe² to Mn²⁺ was 2:8, and a molar ratio of a sum of ferrous ions and manganese ions (Fe²⁺+Mn²⁺) to PO₄³⁻ was 3:2. A reaction liquid was prepared, and stirring was performed, where the reaction liquid was a mixed solvent obtained by mixing ethylene glycol and water at a volume ratio of 3:1, a concentration of the oxalic acid solution was 2 mol/L, and a concentration of the acetic acid solution was 0.15 mol/L.
(2) The ternary solution, the oxalic acid solution, and the acetic acid solution were injected into the reaction liquid to obtain a mixed solution. A phase-1 reaction and a phase-2 reaction were performed, where reaction temperatures were adjusted and controlled to be 55° C., and nitrogen gas was continuously injected in the reaction processes.

Phase 1: The foregoing mixed solution was injected to a reactor. Stirring was performed to form an intermediate reaction liquid, where a rotational speed was controlled to be 400 rpm, a concentration of the oxalic acid solution was controlled to be 0.025 mol/L, and a pH value of the mixed solution was adjusted and controlled to be 1.8. A co-precipitation reaction in Phase 1 was performed for 12 hours to obtain a solution containing a precursor crystal nucleus, where this process was a nucleation and kernel growth phase of a precursor, and a particle size Dv50 of the crystal nucleus was 2.6 μm.

Phase 2: The oxalic acid solution and the acetic acid solution were injected into the solution containing the precursor crystal nucleus obtained in Phase 1, where a pH value of the system was adjusted to 2.6, and a concentration of a complexing agent was adjusted and controlled to be 0.15 mol/L. A co-precipitation reaction was performed at a stirring rate of 300 rpm, where this phase was a shell production phase of the precursor. The reaction was terminated after a target particle size Dv50 reached 5.5 μm, to obtain a precursor (Fe_{0.2}Mn_{0.8})₃(PO₄)₂, where a kernel region of the precursor was composed of loosely aggregated tiny particles formed by the foregoing crystal nucleus, a shell region of the precursor was composed of densely aggregated large particles, and both components of the particles of the kernel region and the shell region were (Fe_{0.2}Mn_{0.8})₃(PO₄)₂.
(3) Solid-liquid separation, aging, drying, grinding, sieving, and impurity removal were performed on a slurry obtained after the reaction in step (2), to obtain the precursor (Fe_{0.2}Mn_{0.8})₃(PO₄)₂.
(4) Ball-milling mixing was performed on the precursor (Fe_{0.2}Mn_{0.8})₃(PO₄)₂ in step (3), (NH₄)H₂PO₄, LiOH, and glucose, where a molar ratio of (NH₄)H₂PO₄ to a sum of ferrous ions and manganese ions (Fe²⁺+Mn²⁺) was 1.02:1, and a molar ratio of LiOH to the sum of the ferrous ions and the manganese ions (Fe²⁺+Mn²⁺) was 1.05:1. Glucose and the precursor were mixed at a mass ratio of 0.08:1. High-temperature roasting was performed in an inert atmosphere, where a multi-stage temperature-controlled sintering manner was used in a sintering process, a temperature was first raised from a room temperature to 550° C. at a heating rate of 3° C./min, heat preservation was first performed at 550° C. for 6 hours, then the temperature was raised to 680° C., and heat preservation was performed again for 10 hours. Natural cooling to the room temperature was performed, to obtain a lithium manganese iron phosphate positive electrode material having a carbon-coated structure and denoted as LiFe_{0.2}Mn_{0.8}PO₄/C, where a carbon content tested with a carbon-sulfur detector was 1.5% (mass ratio), and a specific surface area (BET value) is shown in Table 1. It may be learned by using a porosity tester that porosities of the kernel region and the shell region were 78% and 22%, respectively.

FIG. 5 is an XRD spectrum of the lithium manganese iron phosphate positive electrode material in Example 5. It may be learned that a solid solution material was prepared. A PDF card matching result was lithium manganese iron phosphate.

FIG. 6 is an SEM image of the lithium manganese iron phosphate positive electrode material in Example 5. It may be learned from the figure that a spherical particle was prepared. A size of the particle ranged from 4 μm to 5 μm.

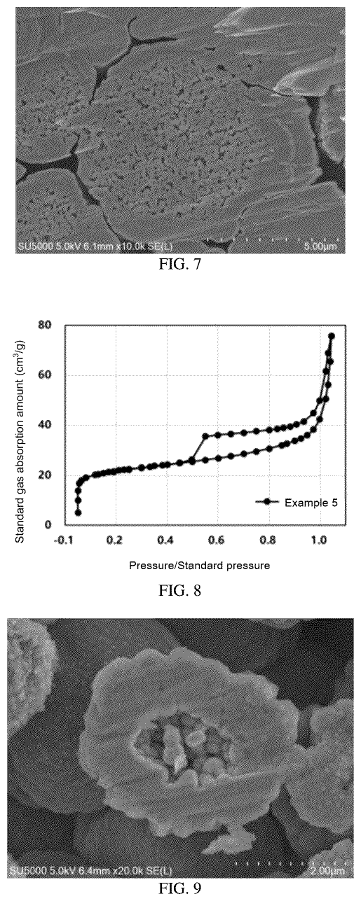

FIG. 7 is an SEM image of a section of a particle of the positive electrode material in Example 5. It may be learned that the kernel region of the positive electrode material was composed of loosely aggregated particles, that the shell region thereof was composed of densely aggregated particles, and that the kernel region had a loose structure, and partially had a hollow structure.

FIG. 8 is a graph of nitrogen gas adsorption-desorption curves of the lithium manganese iron phosphate positive electrode material in Example 5. It may be learned from the figure that the curves had obvious retention rings. The prepared material had a mesoporous structure.

II. Assembly of a button battery: The positive electrode material, a conductive agent acetylene black, and a binder PVDF were weighed at a mass ratio of 90:5:5 and evenly mixed. An NMP solvent was dispersed to form a slurry. The slurry was evenly applied on aluminum foil and dried at 80° C. for 12 hours, to obtain a positive electrode plate. Roll-pressing and cutting were sequentially performed on the dried positive electrode plate, to obtain a wafer. The wafer was placed in a glove box for standby use. A 2032-type button battery was assembled by using the wafer prepared above as a positive electrode, using lithium metal as a negative electrode, using Celgard 2400 (micropore polypropylene film) as a separator, and using 1 mol/L of LiPF₆ (EC:EMC:DMC=1:1:1) as an electrolyte solution. Assembly of the button battery should be performed in a glove box in which argon gas is used as protective gas.

III. Production of a soft-package battery: The soft-package battery was assembled on a lithium-ion battery production line by using the positive electrode material prepared above as a positive electrode, using artificial graphite as a negative electrode, and using a commercialized electrolyte solution and a separator. A positive electrode plate included: the positive electrode material, conductive agents (conductive carbon black+carbon nanotube, a mass ratio thereof was 1.5:0.5), and a binder PVDF that were evenly mixed at a mass ratio of 96.5:2:1.5, where NMP was used as a solvent, the mixture was evenly stirred to obtain a slurry, the slurry was applied on an aluminum foil current collector, a positive electrode current collector was (10+2) μm carbon-coated aluminum foil, and high-temperature baking, roll-pressing, and cutting were sequentially performed on an electrode plate to obtain the positive electrode plate for standby use. A negative electrode plate included: artificial graphite, a conductive agent acetylene black, CMC-Na, and a binder LA133 (from CHENG INDIGO POWER SOURCES CO., LTD) that were evenly mixed at a mass ratio of 96.5:1:1:1.5, where deionized water was used as a solvent, the mixture was evenly stirred to obtain a slurry, the slurry was applied on a negative electrode current collector, 6 m copper foil was used as the negative electrode current collector, and cutting was performed to obtain the negative electrode plate for standby use. A mixture of 1 mol/L of LiPF₆ (EC:EMC:DMC=1:1:1) and an additive (lithium bis(fluorosulfonyl)imide) was used as a electrolyte solution. A 7 m+3 μm separator with a mixed coating (a substrate+a PVDF & ceramics mixed coating) was used as the separator.

### Example 6

### I. Preparation of a Positive Electrode Material

(1) A ternary solution, a citric acid solution, and a carbonic acid solution were separately prepared for standby use, where the ternary solution included FeC₂O₄, MnC₂O₄, and (NH₄)H₂PO₄, a total molar concentration of the ternary solution was 1.25 mol/L, a molar ratio of Fe²⁺ to Mn²⁺ was 3:7, and a molar ratio of a sum of ferrous ions and manganese ions (Fe²⁺+Mn²⁺) to PO₄³⁻ was 3.15:2. A reaction liquid was prepared, and stirring was performed, where the reaction liquid was a mixed solvent obtained by mixing polyethylene glycol 400 and water at a volume ratio of 2:1, a concentration of the citric acid solution was 1.5 mol/L, and a concentration of the carbonic acid solution was 0.1 mol/L.
(2) The ternary solution, the citric acid solution, and the carbonic acid solution were injected into the reaction liquid to obtain a mixed solution. A phase-1 reaction and a phase-2 reaction were performed, where reaction temperatures were adjusted and controlled to be 60° C., and nitrogen gas was continuously injected in the reaction processes.

Phase 1: The foregoing mixed solution was injected to a reactor. Stirring was performed to form an intermediate reaction liquid, where a rotational speed was controlled to be 500 rpm, a concentration of the citric acid solution was controlled to be 0.03 mol/L, and a pH value of the mixed solution was adjusted and controlled to be 1.7. A co-precipitation reaction in Phase 1 was performed for 10 hours to obtain a solution containing a precursor crystal nucleus, where this process was a nucleation and kernel growth phase of a precursor, and a particle size Dv50 of the crystal nucleus was 2.5 μm.

Phase 2: The citric acid solution and the carbonic acid solution were injected into the solution containing the precursor crystal nucleus obtained in Phase 1, where a pH value of the system was adjusted to 2.6, and a concentration of a complexing agent was adjusted and controlled to be 0.2 mol/L. A co-precipitation reaction was performed at a stirring rate of 400 rpm, where this phase was a shell production phase of the precursor. The reaction was terminated after a target particle size Dv50 reached 4.8 μm, to obtain a precursor (Fe_{0.3}Mn_{0.7})₃(PO₄)₂, where a kernel region of the precursor was composed of loosely aggregated tiny particles, a shell region of the precursor was composed of densely aggregated large particles, and both components of the particles of the kernel region and the shell region were (Fe_{0.3}Mn_{0.7})₃(PO₄)₂.
(3) Solid-liquid separation, aging, drying, grinding, sieving, and impurity removal were performed on a slurry obtained after the reaction, to obtain the precursor (Fe_{0.3}Mn_{0.7})₃(PO₄)₂.
(4) Ball-milling mixing was performed on the precursor (Fe_{0.3}Mn_{0.7})₃(PO₄)₂ prepared above, (NH₄)H₂PO₄, Li₂CO₃, and sucrose, where a molar ratio of (NH₄)₂HPO₄ to a sum of ferrous ions and manganese ions (Fe²⁺+Mn²⁺) was 1.05:1, and a molar ratio of Li₂CO₃ to the sum of the ferrous ions and the manganese ions (Fe₂₊+Mn²⁺) was 0.98:1. Sucrose and the precursor were mixed at a mass ratio of 0.07:1. High-temperature roasting was performed in an inert atmosphere, where a multi-stage temperature-controlled sintering manner was used in a sintering process, a temperature was raised from a room temperature to 580° C. at a heating rate of 3° C./min, heat preservation was first performed at 580° C. for 5 hours, then the temperature was raised to 700° C., and heat preservation was performed again for 8 hours. Natural cooling to the room temperature was performed, to obtain LiFe_{0.3}Mn_{0.7}PO₄/C having a carbon-coated structure, where a carbon content tested with a carbon-sulfur detector was 1.6% (mass ratio), and a specific surface area (BET value) is shown in Table 1. It may be learned by using a porosity tester that porosities of the kernel region and the shell region were 80% and 25%, respectively.

II. Assembly of a button battery: Steps are the same as those in Example 5.

III. Production of a soft-package battery: Steps are the same as those in Example 5.

### Example 7

### I. Preparation of a Positive Electrode Material

(1) A ternary solution, a citric acid solution, and an acetic acid solution were separately prepared for standby use, where the ternary solution included (CH₃COO)₂Fe, (CH₃COO)₂Mn, and (NH₄)₂HPO₄, a total molar concentration of the ternary solution was 1.75 mol/L, a molar ratio of Fe²⁺ to Mn²⁺ was 4:6, and a molar ratio of a sum of ferrous ions and manganese ions (Fe²⁺+Mn²⁺) to PO₄³⁻ was 3.06:2. A reaction liquid was prepared, and stirring was performed, where the reaction liquid was a mixed solvent obtained by mixing ethylene glycol and water at a volume ratio of 2:1, a concentration of the citric acid solution was 1.75 mol/L, and a concentration of the acetic acid solution was 0.25 mol/L.
(2) The ternary solution, the citric acid solution, and the acetic acid solution were injected into the reaction liquid to obtain a mixed solution. A phase-1 reaction and a phase-2 reaction were performed, where reaction temperatures were adjusted and controlled to be 65° C., and nitrogen gas was continuously injected in the reaction processes.

Phase 1: The foregoing mixed solution was injected to a reactor. Stirring was performed to form an intermediate reaction liquid, where a rotational speed was controlled to be 450 rpm, a concentration of the citric acid solution was controlled to be 0.035 mol/L, and a pH value of the mixed solution was adjusted and controlled to be 2.0. A co-precipitation reaction in Phase 1 was performed for 10 hours to obtain a solution containing a precursor crystal nucleus, where this process was a nucleation and kernel growth phase of a precursor, and a particle size Dv50 of the crystal nucleus was 2.6 μm.

Phase 2: The citric acid solution and the acetic acid solution were injected into the solution containing the precursor crystal nucleus obtained in Phase 1, where a pH value of the system was adjusted to 2.8, and a concentration of a complexing agent was adjusted and controlled to be 0.15 mol/L. A co-precipitation reaction was performed at a stirring rate of 400 rpm, where this phase was a shell production phase of the precursor. The reaction was terminated after a target particle size Dv50 reached 5.8 μm, to obtain a precursor (Fe_{0.4}Mn_{0.6})₃(PO₄)₂, where a kernel region of the precursor was composed of loosely aggregated tiny particles, a shell region of the precursor was composed of densely aggregated large particles, and both components of the particles of the kernel region and the shell region were (Fe_{0.4}Mn_{0.6})₃(PO₄)₂.
(3) Solid-liquid separation, aging, drying, grinding, sieving, and impurity removal were performed on a slurry obtained after the reaction, to obtain the precursor (Fe_{0.4}Mn_{0.6})₃(PO₄)₂.
(4) Ball-milling mixing was performed on the precursor (Fe_{0.4}Mn_{0.6})₃(PO₄)₂ prepared above, (NH₄)H₂PO₄, CH₃COOLi, and a conductive polymer polyaniline, where a molar ratio of (NH₄)H₂PO₄ to (Fe_{0.4}Mn_{0.6})₃(PO₄)₂ was 1.04:0.33, and a molar ratio of CH₃COOLi to (Fe_{0.4}Mn_{0.6})₃(PO₄)₂ was 1.02:0.33. The conductive polymer polyaniline and the precursor were mixed at a mass ratio of 0.10:1. High-temperature roasting was performed in an inert atmosphere, where a multi-stage temperature-controlled sintering manner was used in a sintering process, a temperature was raised from a room temperature to 550° C. at a heating rate of 3° C./min, heat preservation was first performed at 550° C. for 4 hours, then the temperature was raised to 720° C., and heat preservation was performed again for 8 hours. A sample was naturally cooled to the room temperature, to obtain LiFe_{0.4}Mn_{0.6}PO₄/C having a carbon-coated structure, where a carbon content tested with a carbon-sulfur detector was 2.1% (mass ratio), and a specific surface area (BET value) is shown in Table 1. It may be learned by using a porosity tester that porosities of the kernel region and the shell region were 82% and 24%, respectively.

II. Assembly of a button battery: Steps are the same as those in Example 5.

III. Production of a soft-package battery: Steps are the same as those in Example 5.

### Example 8

### I. Preparation of a Positive Electrode Material

(1) A ternary solution, a citric acid solution, and a carbonic acid solution were separately prepared for standby use, where the ternary solution included FeCl₂, MnSO₄, and H₃PO₄, a total molar concentration of the ternary solution was 1.25 mol/L, a molar ratio of Fe²⁺ to Mn²⁺ was 2:8, and a molar ratio of a sum of ferrous ions and manganese ions (Fe²⁺+Mn²⁺) to PO₄³⁻ was 3.1:2. A reaction liquid was prepared, and stirring was performed, where the reaction liquid was a mixed solvent obtained by mixing polyethylene glycol 200 and water at a volume ratio of 2:1, a concentration of citric acid solution was 2.25 mol/L, and a concentration of the carbonic acid solution was 0.2 mol/L.
(2) The ternary solution, the citric acid solution, and the carbonic acid solution were injected into the reaction liquid to obtain a mixed solution. A phase-1 reaction and a phase-2 reaction were performed, where reaction temperatures were adjusted and controlled to be 60° C., and nitrogen gas was continuously injected in the reaction processes.

Phase 1: The foregoing mixed solution was injected to a reactor. Stirring was performed to form an intermediate reaction liquid, where a rotational speed was controlled to be 450 rpm, a concentration of the citric acid solution was controlled to be 0.025 mol/L, and a pH value of the mixed solution was adjusted and controlled to be 2.2. A co-precipitation reaction in Phase 1 was performed for 15 hours to obtain a solution containing a precursor crystal nucleus, where this process was a nucleation and kernel growth phase of a precursor, and a particle size Dv50 of the crystal nucleus was 2.75 μm.

Phase 2: The citric acid solution and the carbonic acid solution were injected into the solution containing the precursor crystal nucleus obtained in Phase 1, where a pH value of the system was adjusted to 2.8, and a concentration of a complexing agent was adjusted and controlled to be 0.2 mol/L. A co-precipitation reaction was performed at a stirring rate of 400 rpm, where this phase was a shell production phase of the precursor. The reaction was terminated after a target particle size Dv50 reached 6.0 μm, to obtain a precursor (Fe_{0.2}Mn_{0.8})₃(PO₄)₂, where a kernel region of the precursor was composed of loosely aggregated tiny particles, a shell region of the precursor was composed of densely aggregated large particles, and both components of the particles of the kernel region and the shell region were (Fe_{0.2}Mn_{0.8})₃(PO₄)₂.
(3) Solid-liquid separation, aging, drying, grinding, sieving, and impurity removal were performed on a slurry obtained after the reaction, to obtain the precursor (Fe_{0.2}Mn_{0.8})₃(PO₄)₂.
(4) Ball-milling mixing was performed on the precursor (Fe_{0.2}Mn_{0.8})₃(PO₄)₂ prepared above, (NH₄)H₂PO₄, Li₂CO₃, and a conductive polymer PEDOT, where a molar ratio of (NH₄)H₂PO₄ to a sum of ferrous ions and manganese ions (Fe²⁺+Mn²⁺) was 1:1, and a molar ratio of Li₂CO₃ to the sum of the ferrous ions and the manganese ions (Fe²⁺+Mn²⁺) was 1.02:1. The conductive polymer PEDOT and the precursor were mixed at a mass ratio of 0.09:1. High-temperature roasting was performed in an inert atmosphere, where a multi-stage temperature-controlled sintering manner was used in a sintering process, a temperature was raised from a room temperature to 580° C. at a heating rate of 3° C./min, heat preservation was first performed at 580° C. for 4 hours, then the temperature was raised to 680° C., and heat preservation was performed again for 10 hours. A sample was naturally cooled to the room temperature, to obtain a positive electrode material having a carbon-coated structure and denoted as LiFe_{0.2}Mn_{0.8}PO₄/C, where a carbon content tested with a carbon-sulfur detector was 1.8% (mass ratio), and a specific surface area (BET value) is shown in Table 1. It may be learned by using a porosity tester that porosities of the kernel region and the shell region were 85% and 26%, respectively.

II. Assembly of a button battery: Steps are the same as those in Example 5.

III. Production of a soft-package battery: Steps are the same as those in Example 5.

### Example 9

### I. Preparation of a Positive Electrode Material

(1) A ternary solution, a mixing solution, an oxalic acid solution, and a carbonic acid solution were separately prepared for standby use, where the ternary solution included FeSO₄, MnSO₄, and H₃PO₄, a total molar concentration of the ternary solution was 1.25 mol/L, a molar ratio of Fe²⁺ to Mn²⁺ was 2.5:7.5, and a molar ratio of a sum of ferrous ions and manganese ions (Fe²⁺+Mn²⁺) to PO₄³⁻ was 3.06:2. The mixing solution included VCl₅ and NbCl₅. A molar ratio of V⁵⁺ to Nb⁵⁺ was 1:2. A reaction liquid was prepared, and stirring was performed, where the reaction liquid was a mixed solvent obtained by mixing ethylene glycol and water at a volume ratio of 2:1, a concentration of the oxalic acid solution was 1.5 mol/L, and a concentration of the carbonic acid solution was 0.125 mol/L.
(2) The ternary solution, the mixing solution, the oxalic acid solution, and the carbonic acid solution were injected into the reaction liquid to obtain a mixed solution. A molar ratio of (Fe²⁺+Mn²⁺) to (V⁵⁺+Nb⁵⁺) was 99.5:0.5. A phase-1 reaction and a phase-2 reaction were performed, where reaction temperatures were adjusted and controlled to be 60° C., and nitrogen gas was continuously injected in the reaction processes.

Phase 1: The foregoing mixed solution was injected to a reactor. Stirring was performed to form an intermediate reaction liquid, where a rotational speed was controlled to be 450 rpm, a concentration of the oxalic acid solution was controlled to be 0.025 mol/L, and a pH value of the mixed solution was adjusted and controlled to be 1.6. A co-precipitation reaction in Phase 1 was performed for 15 hours to obtain a solution containing a precursor crystal nucleus, where this process was a nucleation and kernel growth phase of a precursor, and a particle size Dv50 of the crystal nucleus was 2.5 μm.

Phase 2: The oxalic acid solution and the carbonic acid solution were injected into the solution containing the precursor crystal nucleus obtained in Phase 1, where a pH value of the system was adjusted to 2.8, and a concentration of a complexing agent was adjusted and controlled to be 0.15 mol/L. A co-precipitation reaction was performed at a stirring rate of 400 rpm, where this phase was a shell production phase of the precursor. The reaction was terminated after a target particle size Dv50 reached 4.0 μm, to obtain a doped precursor, where a kernel region of the doped precursor was composed of loosely aggregated tiny particles, a shell region of the doped precursor was composed of densely aggregated large particles, and components of the particles of the kernel region and the shell region were consistent with each other.
(3) Solid-liquid separation, aging, drying, grinding, sieving, and impurity removal were performed on a slurry obtained after the reaction in step (2), to obtain a co-doped precursor.
(4) Ball-milling mixing was performed on the co-doped precursor prepared in step (3), (NH₄)H₂PO₄, Li₂CO₃, and sucrose, where a molar ratio of PO₄³⁻ in (NH₄)H₂PO₄ to a sum of ferrous ions, manganese ions, vanadium ions, and niobium ions in the mixed solution in step (2) was 1.02:1, and a molar ratio of Li⁺ in Li₂CO₃ to the sum of the ferrous ions, the manganese ions, the vanadium ions, and the niobium ions in the mixed solution in step (2) was 1.05:1. Sucrose and the co-doped precursor were mixed at a mass ratio of 0.08:1. High-temperature roasting was performed in an inert atmosphere, where a multi-stage temperature-controlled sintering manner was used in a sintering process, a temperature was first raised from a room temperature to 575° C. at a heating rate of 3° C./min, heat preservation was first performed at 575° C. for 6 hours, then the temperature was raised to 680° C., and heat preservation was performed again for 8 hours. A sample was naturally cooled to the room temperature, to obtain doped lithium manganese iron phosphate having a carbon-coated structure, where a chemical formula of the doped lithium manganese iron phosphate was LiMn_{1-x-y-z}FeₓM_{y}N_{z}PO₄, M and N are co-doping elements and are Nb and V, respectively, x=0.25, y=0.0033, z=0.0017, a carbon content tested with a carbon-sulfur detector was 1.8% (mass ratio), and a specific surface area (BET value) is shown in Table 1. It may be learned by using a porosity tester that porosities of the kernel region and the shell region were 85% and 20%, respectively.

FIG. 9 is an SEM image of a section of a particle of the positive electrode material in Example 9. It may be learned from FIG. 9 that the kernel region of the positive electrode material was composed of loosely aggregated tiny particles, that the shell region thereof was composed of densely aggregated large particles, and that the kernel region had a loose structure, and partially had a hollow structure.

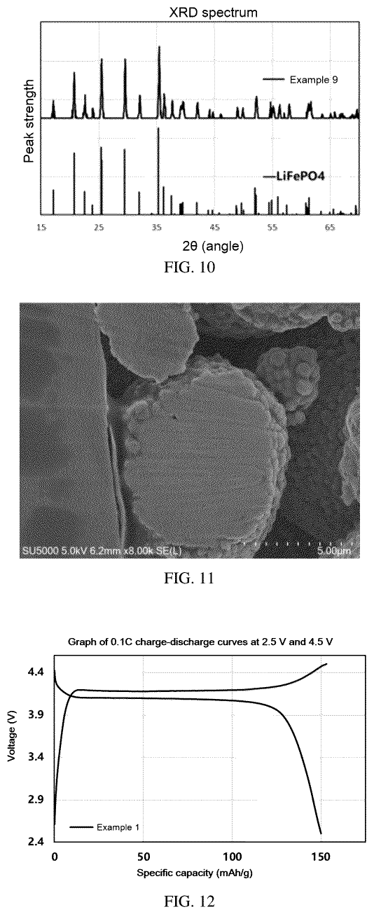

FIG. 10 is an XRD spectrum of the lithium manganese iron phosphate positive electrode material prepared according to a co-doping method in Example 9. It may be learned from FIG. 10 that positions and relative strengths of diffraction peaks did not change significantly with addition of the doping elements. This indicates that the doping elements in the positive electrode material in Example 9 were successfully embedded into a crystal lattice structure, and that a pure solid solution was formed. The prepared positive electrode material was lithium manganese iron phosphate having an olivine structure. In addition, a change of a doping amount did not damage a crystal structure of the material.

II. Assembly of a button battery: Steps are the same as those in Example 5.

III. Production of a soft-package battery: Steps are the same as those in Example 5.

### Example 10

### I. Preparation of a Positive Electrode Material

(1) A solution including FeC₂O₄, MnC₂O₄, and (NH₄)H₂PO₄, a mixing solution including VCl₅ and NbCl₅, a citric acid solution, and an acetic acid solution were prepared for standby use, where a sum molar concentration of FeC₂O₄, MnC₂O₄, and (NH₄)H₂PO₄ was 1.5 mol/L, a molar ratio of Fe²⁺ to Mn²⁺ was 3:7, a molar ratio of a sum of ferrous ions and manganese ions (Fe²⁺+Mn²⁺) to PO₄³⁻ was 3:2, a molar ratio of V⁵⁺ to Nb⁵⁺ in the mixing solution was 1:1, and a molar ratio of (Fe²⁺+Mn²⁺) to (V⁵⁺+Nb⁵⁺) was 99.4:0.6. A reaction liquid was prepared, and stirring was performed, where the reaction liquid was a mixed solvent obtained by mixing polyethylene glycol 200 and water at a volume ratio of 2:1, a concentration of the citric acid solution was 1.75 mol/L, and a concentration of the acetic acid solution was 0.1 mol/L.
(2) The solution including FeC₂O₄, MnC₂O₄, and (NH₄)H₂PO₄, the mixing solution including VCl₅ and NbCl₅, the citric acid solution, and the acetic acid solution were injected into the reaction liquid to obtain a mixed solution. A phase-1 reaction and a phase-2 reaction were performed, where reaction temperatures were adjusted and controlled to be 65° C., and nitrogen gas was continuously injected in the reaction processes.

Phase 1: The foregoing mixed solution was injected to a reactor. Stirring was performed to form an intermediate reaction liquid, where a rotational speed was controlled to be 500 rpm, a concentration of the citric acid solution was controlled to be 0.025 mol/L, and a pH value of the mixed solution was adjusted and controlled to be 1.8. A co-precipitation reaction in Phase 1 was performed for 12 hours to obtain a solution containing a precursor crystal nucleus, where this process was a nucleation and kernel growth phase of a precursor, and a particle size Dv50 of the crystal nucleus was 2.2 μm.

Phase 2: The citric acid solution and the acetic acid solution were injected into the solution containing the precursor crystal nucleus obtained in Phase 1, where a pH value of the system was adjusted to 3.0, and a concentration of a complexing agent was adjusted and controlled to be 0.175 mol/L. A co-precipitation reaction was performed at a stirring rate of 400 rpm, where this phase was a shell production phase of the precursor. The reaction was terminated after a target particle size Dv50 reached 4.5 μm, to obtain a doped precursor, where a kernel region of the doped precursor was composed of loosely aggregated tiny particles, a shell region of the doped precursor was composed of densely aggregated large particles, and components of the particles of the kernel region and the shell region were consistent with each other.
(3) Solid-liquid separation, aging, drying, grinding, sieving, and impurity removal were performed on a slurry obtained after the reaction, to obtain a co-doped precursor.
(4) Ball-milling mixing was performed on the co-doped precursor prepared above, (NH₄)H₂PO₄, LiOH, and sucrose, where a molar ratio of (NH₄)₂HPO₄ to a sum of ferrous ions, manganese ions, vanadium ions, and niobium ions was 1.02:1, and a molar ratio of Li⁺ in Li₂CO₃ to the sum of the ferrous ions, the manganese ions, the vanadium ions, and the niobium ions was 1.0:1. The co-doped precursor and sucrose were mixed at a mass ratio of 1:0.09. High-temperature roasting was performed in an inert atmosphere, where a multi-stage temperature-controlled sintering manner was used in a sintering process, a temperature was first raised from a room temperature to 560° C. at a heating rate of 3° C./min, heat preservation was first performed at 560° C. for 4 hours, then the temperature was raised to 700° C., and heat preservation was performed again for 8 hours. A sample was naturally cooled to the room temperature, to obtain doped lithium manganese iron phosphate having a carbon-coated structure, where a chemical formula of the doped lithium manganese iron phosphate was LiMn_{1-x-y-z}FeₓM_{y}N_{z}PO₄, M and N are co-doping elements and are Nb and V, respectively, x=0.298, y=0.003, z=0.003, a carbon content tested with a carbon-sulfur detector was 2% (mass ratio), and a specific surface area (BET value) is shown in Table 1. It may be learned by using a porosity tester that porosities of the kernel region and the shell region were 82% and 18%, respectively.

II. Assembly of a button battery: Steps are the same as those in Example 5.

III. Production of a soft-package battery: Steps are the same as those in Example 5.

### Example 11

### I. Preparation of a Positive Electrode Material

(1) A solution including (CH₃COO)₂Fe, (CH₃COO)₂Mn, and (NH₄)₂HPO₄, a mixing solution including VCl₅ and NbCl₅, an oxalic acid solution, and an acetic acid solution were prepared for standby use, where a sum molar concentration of (CH₃COO)₂Fe, (CH₃COO)₂Mn, and (NH₄)₂HPO₄ was 2.5 mol/L, a molar ratio of Fe²⁺ to Mn²⁺ was 2:8, a molar ratio of a sum of ferrous ions and manganese ions (Fe²⁺+Mn²⁺) to PO₄³⁻ was 3:2, a molar ratio of V⁵⁺ to Nb⁵⁺ in the mixing solution was 2:1, and a molar ratio of (Fe²⁺+Mn²⁺) to (V⁵⁺+Nb⁵⁺) was 99.4:0.6. A reaction liquid was prepared, and stirring was performed, where the reaction liquid was a mixed solvent obtained by mixing glycerol and water at a volume ratio of 2:1, a concentration of the oxalic acid solution was 1.5 mol/L, and a concentration of the acetic acid solution was 0.15 mol/L.
(2) The solution including (CH₃COO)₂Fe, (CH₃COO)₂Mn, and (NH₄)₂HPO₄, the mixing solution including VCl₅ and NbCl₅, the oxalic acid solution, and the acetic acid solution were injected into the reaction liquid to obtain a mixed solution. A phase-1 reaction and a phase-2 reaction were performed, where reaction temperatures were adjusted and controlled to be 55° C., and nitrogen gas was continuously injected in the reaction processes.

Phase 1: The foregoing mixed solution was injected to a reactor. Stirring was performed to form an intermediate reaction liquid, where a rotational speed was controlled to be 400 rpm, a concentration of the oxalic acid solution was controlled to be 0.03 mol/L, and a pH value of the mixed solution was adjusted and controlled to be 2.0. A co-precipitation reaction in Phase 1 was performed for 12 hours to obtain a solution containing a precursor crystal nucleus, where this process was a nucleation and kernel growth phase of a precursor, and a particle size Dv50 of the crystal nucleus was 2.4 μm.

Phase 2: The oxalic acid solution and the acetic acid solution were injected into the solution containing the precursor crystal nucleus obtained in Phase 1, where a pH value of the system was adjusted to 3.2, and a concentration of a complexing agent was adjusted and controlled to be 0.2 mol/L. A co-precipitation reaction was performed at a stirring rate of 350 rpm, where this phase was a shell production phase of the precursor. The reaction was terminated after a target particle size Dv50 reached 3.5 μm, to obtain a doped precursor, where a kernel region of the doped precursor was composed of loosely aggregated tiny particles, a shell region of the doped precursor was composed of densely aggregated large particles, and components of the particles of the kernel region and the shell region were consistent with each other.
(3) Solid-liquid separation, aging, drying, grinding, sieving, and impurity removal were performed on a slurry obtained after the reaction, to obtain a co-doped precursor.
(4) Ball-milling mixing was performed on the co-doped precursor prepared above, (NH₄)₂HPO₄, CH₃COOLi, and lemon sugar, where a molar ratio of (NH₄)H₂PO₄ to a sum of ferrous ions, manganese ions, vanadium ions, and niobium ions was 1.04:1, and a molar ratio of Li⁺ in CH₃COOLi to the sum of the ferrous ions, the manganese ions, the vanadium ions, and the niobium ions was 1.02:1. The co-doped precursor and lemon sugar were mixed at a mass ratio of 1:0.1. High-temperature roasting was performed in an inert atmosphere, where a multi-stage temperature-controlled sintering manner was used in a sintering process, a temperature was first raised from a room temperature to 580° C. at a heating rate of 3° C./min, heat preservation was first performed at 580° C. for 6 hours, then the temperature was raised to 720° C., and heat preservation was performed again for 12 hours. A sample was naturally cooled to the room temperature, to obtain doped lithium manganese iron phosphate having a carbon-coated structure, where a chemical formula of the doped lithium manganese iron phosphate was LiMn_{1-x-y-z}FeₓM_{y}N_{z}PO₄, M and N are co-doping elements and are Nb and V, respectively, x=0.198, y=0.002, z=0.004, a carbon content tested with a carbon-sulfur detector was 2.2% (mass ratio), and a specific surface area (BET value) is shown in Table 1. It may be learned by using a porosity tester that porosities of the kernel region and the shell region were 86% and 22%, respectively.

II. Assembly of a button battery: Steps are the same as those in Example 5.

III. Production of a soft-package battery: Steps are the same as those in Example 5.

### Example 12

### I. Preparation of a Positive Electrode Material

(1) A solution including FeCl₂, MnCl₂, and H₃PO₄, a mixing solution including VCl₅ and NbCl₅, a citric acid solution, and an acetic acid solution were prepared for standby use, where a sum molar concentration of FeCl₂, MnCl₂, and H₃PO₄ was 1.25 mol/L, a molar ratio of Fe²⁺ to Mn²⁺ was 3.5:6.5, a molar ratio of a sum of ferrous ions and manganese ions (Fe²⁺+Mn²⁺) to PO₄³⁻ was 3.15:2, a molar ratio of V⁵⁺ to Nb⁵⁺ in the mixing solution was 1:1, and a molar ratio of (Fe²⁺+Mn²⁺) to (V⁵⁺+Nb⁵⁺) was 99.6:0.4. A reaction liquid was prepared, and stirring was performed, where the reaction liquid was a mixed solvent obtained by mixing ethylene glycol and water at a volume ratio of 2:1, a concentration of the citric acid solution was 1.75 mol/L, and a concentration of the acetic acid solution was 0.2 mol/L.
(2) The solution including FeCl₂, MnCl₂, and H₃PO₄, the mixing solution including VCl₅ and NbCl₅, the citric acid solution, and the acetic acid solution were injected into the reaction liquid to obtain a mixed solution. A phase-1 reaction and a phase-2 reaction were performed, where reaction temperatures were adjusted and controlled to be 60° C., and nitrogen gas was continuously injected in the reaction processes.

Phase-1: The foregoing mixed solution was injected to a reactor. Stirring was performed to form an intermediate reaction liquid, where a rotational speed was controlled to be 450 rpm, a concentration of the citric acid solution was controlled to be 0.025 mol/L, and a pH value of the mixed solution was adjusted and controlled to be 1.8. A co-precipitation reaction in Phase 1 was performed for 12 hours to obtain a solution containing a precursor crystal nucleus, where this process was a nucleation and kernel growth phase of a precursor, and a particle size Dv50 of the crystal nucleus was 2.6 μm.

Phase-2: The citric acid solution and the acetic acid solution were injected into the solution containing the precursor crystal nucleus obtained in Phase 1, where a pH value of the system was adjusted to 2.8, and a concentration of a complexing agent was adjusted and controlled to be 0.2 mol/L. A co-precipitation reaction was performed at a stirring rate of 400 rpm, where this phase was a shell production phase of the precursor. The reaction was terminated after a target particle size Dv50 reached 4.0 μm, to obtain a doped precursor, where a kernel region of the doped precursor was composed of loosely aggregated tiny particles, a shell region of the doped precursor was composed of densely aggregated large particles, and components of the particles of the kernel region and the shell region were consistent with each other.
(3) Solid-liquid separation, aging, drying, grinding, sieving, and impurity removal were performed on a slurry obtained after the reaction, to obtain a co-doped precursor.
(4) Ball-milling mixing was performed on the co-doped precursor prepared above, (NH₄)₂HPO₄, Li₂CO₃, and glucose, where a molar ratio of (NH₄)H₂PO₄ to a sum of ferrous ions, manganese ions, vanadium ions, and niobium ions was 1.02:1, and a molar ratio of Li⁺ in Li₂CO₃ to the sum of the ferrous ions, the manganese ions, the vanadium ions, and the niobium ions was 0.98:1. The co-doped precursor and glucose were mixed at a mass ratio of 1:0.08. High-temperature roasting was performed in an inert atmosphere, where a multi-stage temperature-controlled sintering manner was used in a sintering process, a temperature was first raised from a room temperature to 560° C. at a heating rate of 3° C./min, heat preservation was first performed at 560° C. for 5 hours, then the temperature was raised to 700° C., and heat preservation was performed again for 10 hours. A sample was naturally cooled to the room temperature, to obtain doped lithium manganese iron phosphate having a carbon-coated structure, where a chemical formula of the doped lithium manganese iron phosphate was LiMn_{1-x-y-z}FeₓM_{y}N_{z}PO₄, M and N are co-doping elements and are Nb and V, respectively, x=0.3486, y=0.003, z=0.001, a carbon content tested with a carbon-sulfur detector was 1.8% (mass ratio), and a specific surface area (BET value) is shown in Table 1. It may be learned by using a porosity tester that porosities of the kernel region and the shell region were 82% and 18%, respectively.

II. Assembly of a button battery: Steps are the same as those in Example 5.

III. Production of a soft-package battery: Steps are the same as those in Example 5.

### Comparative Example 2

### I. Preparation of a Positive Electrode Material

(1) A ternary solution, an oxalic acid solution, and a carbonic acid solution were separately prepared for standby use, where the ternary solution included (CH₃COO)₂Fe, MnC₂O₄, and H₃PO₄, a total molar concentration of the ternary solution was 1.5 mol/L, a molar ratio of Fe²⁺ to Mn²⁺ was 3:7, and a molar ratio of a sum of ferrous ions and manganese ions (Fe²⁺+Mn²⁺) to PO₄³⁻ was 3.15:2. A reaction liquid was prepared, and stirring was performed, where the reaction liquid was a mixed solvent obtained by mixing polyethylene glycol 200 and water at a volume ratio of 2:1, a concentration of the oxalic acid solution was 2.0 mol/L, and a concentration of the carbonic acid solution was 0.15 mol/L.
(2) The ternary solution, the oxalic acid solution, and the carbonic acid solution were injected into the reaction liquid to obtain a mixed solution. A co-precipitation reaction was performed, where a reaction temperature was adjusted and controlled to be 60° C., and nitrogen gas was continuously injected in the reaction process.

The foregoing mixed solution was injected into a reactor. An addition amount of the carbonic acid solution was finely adjusted to adjust a pH value of the system to 2.6, where a concentration of a complexing agent was adjusted and controlled to be 0.15 mol/L. A co-precipitation reaction was performed at a stirring rate of 400 rpm. The reaction was terminated after a target particle size Dv50 reached 6.0 μm, to obtain a precursor (Fe_{0.3}Mn_{0.7})₃(PO₄)₂.
(3) Solid-liquid separation, aging, drying, grinding, sieving, and impurity removal were performed on a slurry obtained after the reaction, to obtain the precursor (Fe_{0.3}Mn_{0.7})₃(PO₄)₂.
(4) Ball-milling mixing was performed on the precursor (Fe_{0.3}Mn_{0.7})₃(PO₄)₂ prepared above, (NH₄)₂HPO₄, LiOH, and glucose, where a molar ratio of (Fe_{0.3}Mn_{0.7})₃(PO₄)₂ to (NH₄)₂HPO₄ to LiOH was 0.33:1.05:1.02. Glucose and the precursor were mixed at a mass ratio of 0.08:1. High-temperature roasting was performed in an inert atmosphere, where a multi-stage temperature-controlled sintering manner was used in a sintering process, a temperature was raised from a room temperature to 560° C. at a heating rate of 3° C./min, heat preservation was first performed at 560° C. for 5 hours, then the temperature was raised to 700° C., and heat preservation was performed again for 8 hours. A sample was naturally cooled to the room temperature, to obtain LiFe_{0.3}Mn_{0.7}PO₄/C having a carbon-coated structure, where a carbon content tested with a carbon-sulfur detector was 1.6% (mass ratio), and a specific surface area (BET value) is shown in Table 1.

FIG. 11 is an SEM image of a section of the lithium manganese iron phosphate positive electrode material positive electrode material in Comparative Example 2. It may be learned from the figure that a solid spherical particle was prepared in Comparative Example 2. From the SEM image of the section of the particle of the positive electrode material in Example 5 shown in FIG. 7, it may be learned that the kernel region of the positive electrode material in Example 5 was composed of loosely aggregated particles, that the shell region thereof was composed of densely aggregated particles, and that the kernel region had a hollow structure.

II. Assembly of a button battery: Steps are the same as those in Example 5.

III. Production of a soft-package battery: Steps are the same as those in Example 5.

### Example 13

### I. Preparation of a Positive Electrode Material

(1) A solution including FeSO₄ and H₃PO₄, a mixing solution including VCl₅ and NbCl₅, a citric acid solution, and an acetic acid solution were prepared for standby use, where a molar concentration of FeSO₄ and H₃PO₄ was 1.25 mol/L, a molar ratio of Fe²⁺ to PO₄³⁻ was 3:2, a molar ratio of V⁵⁺ to Nb⁵⁺ in the mixing solution was 1:1, and a molar ratio of Fe²⁺ to (V⁵⁺+Nb⁵⁺) was 99.6:0.4. A reaction liquid was prepared, and stirring was performed, where the reaction liquid was a mixed solvent obtained by mixing ethylene glycol and water at a volume ratio of 2:1, a concentration of the citric acid solution was 1.75 mol/L, and a concentration of the acetic acid solution was 0.2 mol/L.
(2) The solution including FeSO₄ and H₃PO₄, the mixing solution including VCl₅ and NbCl₅, the citric acid solution, and the acetic acid solution were injected into the reaction liquid to obtain a mixed solution. A phase-1 reaction and a phase-2 reaction were performed, where reaction temperatures were adjusted and controlled to be 60° C., and nitrogen gas was continuously injected in the reaction processes.

Phase-1: The foregoing mixed solution was injected to a reactor. Stirring was performed to form an intermediate reaction liquid, where a rotational speed was controlled to be 450 rpm, a concentration of the citric acid solution was controlled to be 0.025 mol/L, and a pH value of the mixed solution was adjusted and controlled to be 1.8. A co-precipitation reaction in Phase 1 was performed for 12 hours to obtain a solution containing a precursor crystal nucleus, where this process was a nucleation and kernel growth phase of a precursor, and a particle size Dv50 of the crystal nucleus was 2.6 μm.

Phase-2: The citric acid solution and the acetic acid solution were injected into the solution containing the precursor crystal nucleus obtained in Phase 1, where a pH value of the system was adjusted to 2.8, and a concentration of a complexing agent was adjusted and controlled to be 0.2 mol/L. A co-precipitation reaction was performed at a stirring rate of 400 rpm, where this phase was a shell production phase of the precursor. The reaction was terminated after a target particle size Dv50 reached 4.0 μm, to obtain a doped precursor, where a kernel region of the doped precursor was composed of loosely aggregated tiny particles, a shell region of the doped precursor was composed of densely aggregated large particles, and components of the particles of the kernel region and the shell region were consistent with each other.
(3) Solid-liquid separation, aging, drying, grinding, sieving, and impurity removal were performed on a slurry obtained after the reaction, to obtain a co-doped precursor.
(4) Ball-milling mixing was performed on the co-doped precursor prepared above, (NH₄)₂HPO₄, Li₂CO₃, and glucose, where a molar ratio of (NH₄)H₂PO₄ to a sum of ferrous ions, vanadium ions, and niobium ions was 1.02:1, and a molar ratio of Li⁺ in Li₂CO₃ to the sum of the ferrous ions, the vanadium ions, and the niobium ions was 0.98:1. The co-doped precursor and glucose were mixed at a mass ratio of 1:0.08. High-temperature roasting was performed in an inert atmosphere, where a multi-stage temperature-controlled sintering manner was used in a sintering process, a temperature was first raised from a room temperature to 560° C. at a heating rate of 3° C./min, heat preservation was first performed at 560° C. for 5 hours, then the temperature was raised to 700° C., and heat preservation was performed again for 10 hours. A sample was naturally cooled to the room temperature, to obtain doped lithium iron phosphate having a carbon-coated structure, where a chemical formula of the doped lithium iron phosphate was LiFeₓM_{y}N_{z}PO₄, M and N are co-doping elements and are Nb and V, respectively, x=0.996, y=0.003, z=0.001, a carbon content tested with a carbon-sulfur detector was 1.8% (mass ratio), and a specific surface area (BET value) is shown in Table 1. It may be learned by using a porosity tester that porosities of the kernel region and the shell region were 75% and 28%, respectively.

II. Assembly of a button battery: Steps are the same as those in Example 1.

III. Production of a soft-package battery: Steps are the same as those in Example 1.

### Test Example

### 1. Charge/Discharge Test

Charge performances of the button batteries in Examples 1 to 12 and Comparative Examples 1 and 2 were tested at 25° C.±5° C. A test process was as follows:
1) The button battery was activated for 24 hours.
2) The button battery was charged to an upper limit voltage 4.5 V at a constant current of 0.1 C, and then charged at a constant voltage, where a cut-off current was 0.025 C.
3) The button battery was left standing for 10 minutes.
4) The button battery was discharged to 2.5 Vat a constant current of 0.1 C.

Example 13 was performed with reference to the foregoing test process. A difference lies in that the upper limit voltage in step 2) was changed from 4.5 V to 3.65 V.

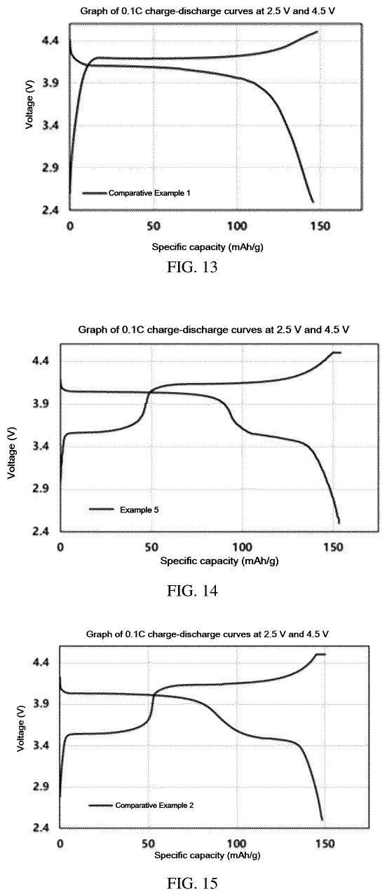

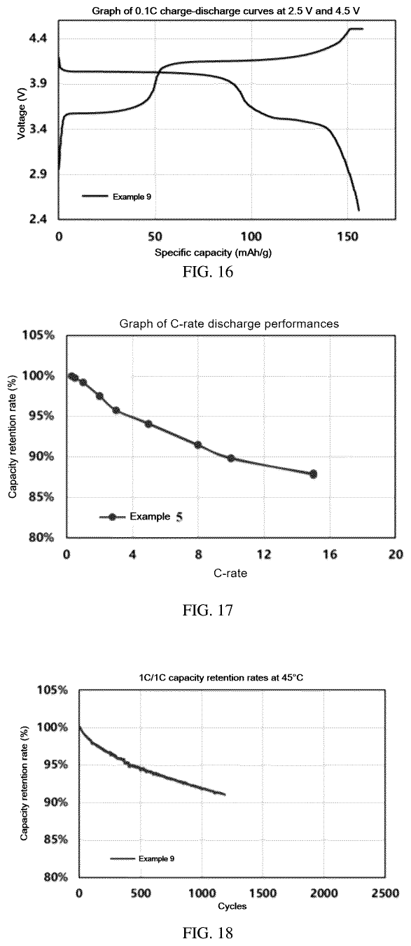

FIG. 12 is a graph of charge-discharge curves of the button battery in Example 1. FIG. 13 is a graph of charge-discharge curves of the button battery in Comparative Example 1. FIG. 14 is a graph of charge-discharge curves of the button battery in Example 5. FIG. 15 is a graph of charge-discharge curves of the button battery in Comparative Example 2. FIG. 16 is a graph of charge-discharge curves in Example 9. Results of capacities per gram for discharging of the positive electrode materials obtained through calculation are shown in Table 1.

### 2. C-Rate Test

C-rate performances of the pouch batteries in Examples 1 to 12 and Comparative Examples 1 and 2 were tested at 25° C.±2° C. A test process was as follows:
1) A capacity was tested after 3 cycles at 25° C.±2° C. and 0.33 C/0.33 C.
2) The pouch battery was discharged to a lower limit voltage (2.5 V) at 1 C.
3) The pouch battery was left standing for 30 minutes.
4) The pouch battery was charged to an upper limit voltage (4.5 V) at a constant current of 1 C, and then charged at a constant voltage, where a cut-off current was 0.05 C.
5) The pouch battery was left standing for 30 minutes.
6) The pouch battery was discharged to the lower limit voltage 2.5 V at nC, where nC=0.2 C/0.33 C/0.5 C/1 C/2 C/3 C/5 C/8 C/10 C/15 C.
7) Steps 3 to 6 were repeated until discharge steps of all the C-rates were completed.

Example 13 was performed with reference to the foregoing test process. A difference lies in that the upper limit voltage in step 4) was changed from 4.5 V to 3.65 V.

C-rate performances (C-rate=nC discharge capacity/0.33 C capacity) of the pouch batteries were obtained through calculation. FIG. 17 is a graph of C-rate performances of the soft-package battery in Example 5. Results of the C-rate performances are shown in Table 1.

### 3. Cycling Capacity Test

Cycling capacities of the pouch batteries in Examples 1 to 12 and Comparative Examples 1 and 2 were separately tested at 25° C.±2° C. and 45° C.±2° C. A test process included:
testing a state voltage, an internal resistance, a thickness, and a DC internal resistance of the pouch battery at 25° C.±2° C. (45° C.±2° C.), where a voltage range was (2.5 V to 4.5 V).
1) The pouch battery was placed in a 25° C.±2° C. (45° C.±2° C.) environment.
2) The pouch battery was discharged to a lower limit voltage at 0.5 C, and then left standing for 30 minutes.
3) The pouch battery was charged to an upper voltage limit at 1 C, where a cut-off current was 0.05 C.
4) The pouch battery was left standing for 30 minutes.
5) The pouch battery was discharged to the lower limit voltage at 1 C, and then left standing for 30 minutes.
6) The pouch battery was charged to the upper limit voltage at 1 C, and then left standing for 30 minutes, where a cut-off current was 0.05 C.

Steps 5 to 6 were performed repeatedly for n cycles.

Example 13 was performed with reference to the foregoing test process. A difference lies in that the voltage range was changed from (2.5 V to 4.5 V) to (2.5 V to 3.65 V).

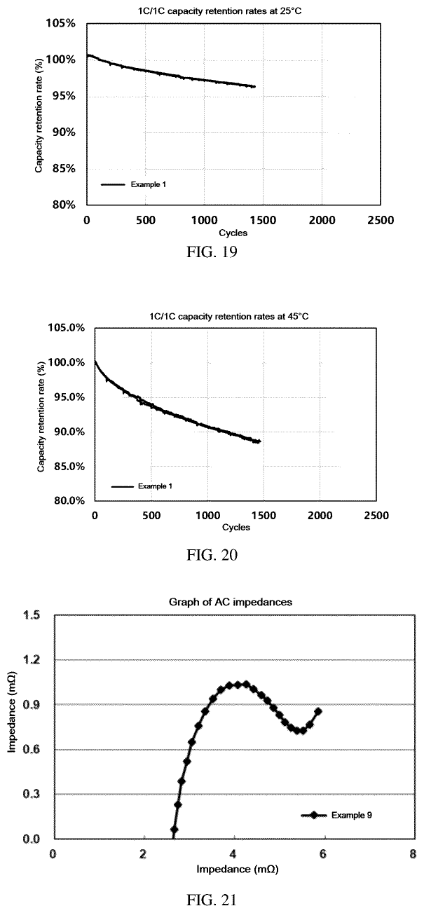

FIG. 19 is a graph of 25° C. cycling capacity retention rates of the soft-package battery in Example 1. FIG. 20 is a graph of 45° C. cycling capacity retention rates of the soft-package battery in Example 1. FIG. 18 is a graph of 45° C. cycling capacity retention rates in Example 9. Cycling capacity retention rates of the batteries were calculated after n (n≤5000) cycles at 1 C/1 C, where a capacity tested after a first cycle was denoted as A1, a capacity tested after n cycles was denoted as An, and a capacity retention rate=An/A1×100%. Results are shown in Table 2.

### 4. Test of a Thermal Decomposition Temperature—DSC Test

The soft-package batteries in Examples 1 to 12 and Comparative Examples 1 and 2 were fully charged to 4.5 V at a C-rate of 0.33 C, and were disassembled in an argon-filled glove box. Positive electrode plates (without positive electrode current collectors) were recycled. The foregoing positive electrode plates were rinsed with dimethyl carbonate (DMC) and then dried. The foregoing positive electrode plate and an electrolyte solution were jointly placed in a high-pressure crucible of a thermal analysis instrument, where 1 mol/L of LiPF₆ (EC:EMC:DMC=1:1:1) was used as the electrolyte solution, the positive electrode plate and the electrolyte solution were added at a ratio of 1 mg to 0.6 μL, a temperature of a thermal analysis test ranged from 25° C. to 500° C., and a heating rate was 5° C./min. Example 13 was performed with reference to the foregoing test process. A difference lies in that the soft-package battery in Example 13 was fully charged to 3.65 V at a C-rate of 0.33 C. Test results are shown in Table 1.

### 5. Test of an EIS Impedance Value—Test Using an AC Impedance Method

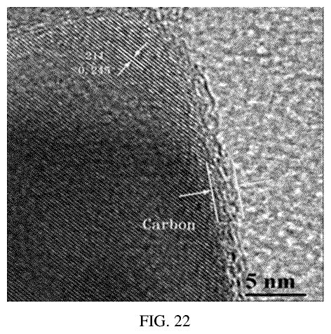

Electrochemical Impedance Spectroscopy (EIS) measurement was performed on an electrochemical workstation CHI600E from Shanghai CH Instruments Co., Ltd. The soft-package batteries in Examples 1 to 12 and Comparative Examples 1 and 2 were tested. A battery state was adjusted to a 50% SOC state. A voltage window was set to 2.5 V to 4.5 V. An amplitude was 5 mV. A frequency range was 10⁻² Hz to 10⁵ Hz. Example 13 was performed with reference to the foregoing test process. A difference lies in that the voltage window was changed from (2.5 V to 4.5 V) to (2.5 V to 3.65 V). FIG. 21 is a graph of impedances in Example 9. Test results are shown in Table 1.

### 6. Test of a Low-Temperature Performance

State voltages, internal resistance, and thicknesses of the pouch batteries in Examples 1 to 4 and Comparative Example 1 were tested at 25° C.±2° C., where a voltage range was (2.5 V to 4.5 V).
1) The pouch battery was left standing at 25° C.±2° C. for 30 minutes.
2) The pouch battery was discharged to a lower limit voltage at 0.5 C.
3) The pouch battery was left standing for 4 hours.
4) The pouch battery was charged to an upper limit voltage at 1 C, where a cut-off current was 0.05 C.
5) The pouch battery was left standing for 4 hours.
6) After being left standing in a thermostat environment at different temperatures (the following temperatures) for 4 hours, the battery was discharged to the lower limit voltage at 1 C.
7) The pouch battery was left standing at 25° C.±2° C. for 4 hours.

Steps 4 to 7 were repeated in a cycling manner until discharge tests at all the temperatures were completed.

The discharge temperatures were 25° C./45° C./0° C./−10° C./−20° C.

Test results are shown in Table 2.
7. Test of an electronic conductivity of a positive electrode material

Sample powder of the positive electrode material prepared in Examples 1 to 4 and Comparative Example 1 was mixed with 5% of PVDF. The mixture was pressed into a cylindrical flake (Φ 10.0 mm) by using a tablet press. An electronic conductivity of an LiMnPO₄/C sample was tested according to a four-probe DC technology. Test results are shown in Table 3.

### 8. Test of a Lithium-Ion Diffusion Coefficient of a Positive Electrode Material

A lithium-ion diffusion coefficient (D_{Li}⁺) of the positive electrode material prepared in Examples 1 to 4 and Comparative Example 1 was tested according to a galvanostatic intermittent titration technique method (GITT method).
1) The button battery was activated for 24 hours.
2) The button battery was charged to an upper limit voltage (4.5 V) at a constant current of 0.1 C, and then charged at a constant voltage, where a cut-off current was 0.05 C.
3) The button battery was left standing for 10 minutes.
4) The button battery was discharged for 15 minutes at a constant current of 0.1 C.
5) The button battery was left standing for 30 minutes.
6) Steps 4 and 5 were repeated until a discharge process was completed.

Example 13 was performed with reference to the foregoing test process. A difference lies in that the upper limit voltage in step 2) was changed from 4.5 V to 3.65 V.

A metal Li negative electrode had a relatively small impact on a voltage change of the battery. A voltage change in the test process was mainly from the positive electrode material. A diffusion coefficient obtained according to this method mainly reflects a diffusion coefficient of the positive electrode material.

Data obtained above was used to calculate a diffusion coefficient of a positive electrode material, focusing on four voltages: a voltage V0 of a battery including the positive electrode material before pulse discharge; an instantaneous voltage V1 of the battery during constant-current discharge (pulse instantaneous discharge), where a difference between V0 and V1 mainly corresponded to an impact of an ohmic impedance, a charge transfer impedance, or the like in the battery on a voltage change; a voltage V2 of the battery when constant-current discharge was finished, where V2 corresponded to a voltage change caused when Li⁺ diffused into the positive electrode material; and a voltage V3 of the battery at the end of standing, where V3 corresponded to diffusion of Li⁺ in an active material. Finally, a steady voltage change of the active material was implemented. A diffusion coefficient Ds of Li⁺ in a lithium-ion battery was calculated based on the foregoing data with reference to Fick's second law according to the following formula:

$$Ds = ( 4 / π t ) {( Rs / 3 )}^{2} {( △ Vs / △ Vt )}^{2} ,$$

where Rs denotes a radius of a spherical particle, t denotes discharge pulse duration, ΔVs=V0−V3, and ΔVt=V1−V2. Test results are shown in Table 3.

TABLE 1
Performances of batteries in Examples 1 to 13 and
Comparative Examples 1 and 2

| | capacity per | C-rate | | | |
|---|---|---|---|---|---|
| | gram for | performance | | Thermal | |
| | discharging | (%) at | | decom- | EIS |
| | (mAh/g) | 25° C. | | position | im- |
| | at 0.1 C | and | BET | tem- | pedance |
| | and 2.5 | 10 C/ | value | perature | value |
| No. | V to 4.5 V | 0.33 C | (m²/g) | (° C.) | (mΩ) |
| Example 1 | 150.5 | 91.2 | 19.2 | 308.6 | 6.75 |
| Example 2 | 150.6 | 90.7 | 18.2 | 306.5 | 6.87 |
| Example 3 | 151.3 | 91.4 | 18.6 | 305.6 | 6.73 |
| Example 4 | 151.2 | 90.6 | 20.2 | 304.8 | 6.81 |
| Example 5 | 152.7 | 92.4 | 13.6 | 275.3 | 4.87 |
| Example 6 | 153.6 | 91.6 | 14.0 | 272.6 | 4.95 |
| Example 7 | 153.3 | 92.2 | 12.8 | 276.5 | 4.88 |
| Example 8 | 154.2 | 91.7 | 15.0 | 274.8 | 5.01 |
| Example 9 | 155.4 | 93.62 | 13.8 | 280.5 | 4.52 |
| Example 10 | 156.0 | 92.85 | 14.2 | 279.8 | 4.65 |
| Example 11 | 155.8 | 93.46 | 13.5 | 279.2 | 4.71 |
| Example 12 | 156.2 | 92.95 | 14.6 | 280.5 | 4.84 |
| Example 13 | 160 | 92 | 12 | 285 | 4.22 |
| Comparative | 146.8 | 86.8 | 11.2 | 288.2 | 9.69 |
| Example 1 | | | | | |
| Comparative | 148.4 | 87.1 | 6.0 | 265.2 | 8.63 |
| Example 2 | | | | | |

TABLE 2
Performances of batteries in Examples 1 to 13
and Comparative Examples 1 and 2

| | Cycling capacity | | Cycling capacity | | Capacity |
|---|---|---|---|---|---|
| | retention rate | | retention rate | | retention |
| | (%) at 25° C. | | (%) at 45° C. | | rate (%) at |
| | and 1 C/1 C | | and 1 C/1 C | | −20° C. |
| No. | n = 1500 | n = 1600 | n = 1500 | n = 1600 | (rated) |
| Example 1 | 96.2 | — | 88.5 | — | 75.39 |
| Example 2 | 95.8 | — | 88.7 | — | 75.52 |
| Example 3 | 96.3 | — | 89.2 | — | 76.08 |
| Example 4 | 95.9 | — | 88.9 | — | 75.86 |
| Example 5 | — | 95.6 | — | 91.2 | — |
| Example 6 | — | 95.6 | — | 90.6 | — |
| Example 7 | — | 94.8 | — | 90.8 | — |
| Example 8 | — | 95.2 | — | 90.2 | — |
| Example 9 | — | 96.2 | — | 90.7 | — |
| Example 10 | — | 95.8 | — | 91.2 | — |
| Example 11 | — | 96.0 | — | 90.8 | — |
| Example 12 | — | 95.6 | — | 91.0 | — |
| Example 13 | — | 96.8 | — | 92.0 | — |
| Comparative | 93.7 | — | 87.1 | — | 62.60 |
| Example 1 | | | | | |
| Comparative | — | 92 | — | 88 | — |
| Example 2 | | | | | |

Note:
“—” indicates that such performance is not tested.

TABLE 3
Performances of batteries in Examples
1 to 4 and Comparative Example 1

| | Electronic | Lithium-ion | Volumetric | Gravimetric |
|---|---|---|---|---|
| | con- | diffusion | energy | energy |
| | ductivity | coefficient | density | density |
| No. | (S/cm) | (D_{Li}⁺) cm²/s | (KWh/m³) | (Wh/kg) |
| Example 1 | 4.25 × 10⁻⁵ | 4.32 × 10⁻¹⁴ | 242 | 200 |
| Example 2 | 6.26 × 10⁻⁵ | 1.85 × 10⁻¹⁴ | 250 | 210 |
| Example 3 | 5.82 × 10⁻⁵ | 3.72 × 10⁻¹⁴ | 245 | 208 |
| Example 4 | 7.24 × 10⁻⁵ | 6.28 × 10⁻¹⁴ | 246 | 205 |
| Example 13 | 2.2 × 10⁻² | 4.0 × 10⁻¹¹ | — | — |
| Comparative | 8.50 × 10⁻⁶ | 5.68 × 10⁻¹⁵ | 228 | 186 |
| Example 1 | | | | |

Note:
“—” indicates that such performance is not tested.

The positive electrode material in Examples 1 to 13 prepared according to the preparation method of the present disclosure included a kernel having an aggregated loose structure and a shell having an aggregated dense structure (as shown in FIG. 3, FIG. 7, and FIG. 9).

It may be learned from the test results in Tables 1 to 3 that the positive electrode material in Examples 1 to 4 had particles with relatively small particle sizes and a special core-shell structure, so that the material had a relatively good lithium-ion diffusion capability, electronic conductivity, and dynamic performance. When the foregoing positive electrode material is prepared into a positive electrode plate, and the positive electrode plate is used at a lithium-ion battery, a dynamic performance and a C-rate discharge capability are relatively good. Moreover, a low-temperature discharge performance and a safety performance are also improved obviously.

It may be learned from the test results in Tables 1 and 2 that the positive electrode material in Examples 5 to 12 had a relatively large specific surface area, a relatively high capacity per gram for discharging, and secondary particles having relatively large particle sizes. When the positive electrode material in Examples 5 to 8 is prepared into a positive electrode plate, and the positive electrode plate is used in a lithium-ion battery, the electrochemical performance of the battery is better than that of a battery using the positive electrode material in Comparative Example 2.

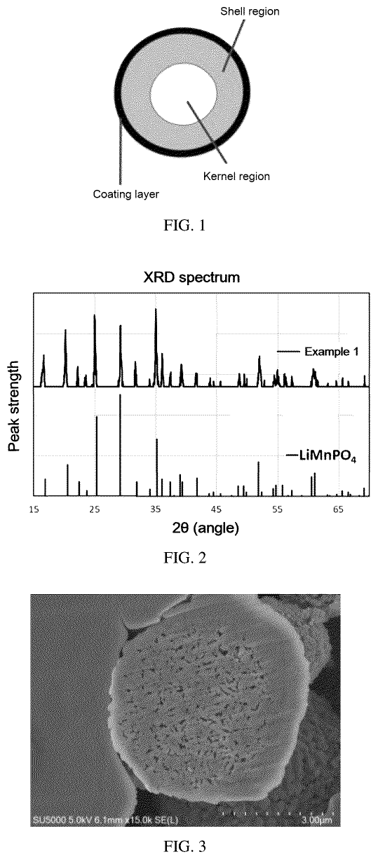

The positive electrode materials prepared in Examples 1 to 13 each included a kernel having an aggregated loose structure and a shell having an aggregated dense structure. A central position of the kernel region had an aggregated loose structure. Further, the central position of the kernel region was hollow. For example, the positive electrode material has a schematic structure shown in FIG. 1.

A microsphere having a core-shell structure is beneficial to improving an infiltration effect of an electrolyte solution and an electronic conductivity of a material. Moreover, due to an inner loose structure, a diffusion distance of lithium ions is shortened, and a C-rate performance and a long-cycling performance of the material are improved obviously.

When the positive electrode material in Examples 5 to 12 is prepared into a positive electrode plate, and the positive electrode plate is used in a lithium-ion battery, the battery is relatively excellent in long-cycling performance, low internal resistance, and high output power.

Therefore, the positive electrode material of the present disclosure is applicable to a battery having a relatively high requirement on a safety performance.

It may be learned from the results in Tables 1 and 2 that according to the positive electrode material in Examples 9 to 12, two elements vanadium and niobium were doped to form an effective synergistic effect, so that an electronic conductivity and a lithium-ion diffusion rate of lithium manganese iron phosphate are also improved obviously, and a capacity per gram for discharging of a material is increased. When the positive electrode material in Examples 9 to 12 is used as a positive electrode of a battery, a C-rate performance of the battery is relatively good. Moreover, co-doping may also improve high-temperature resistance of the positive electrode material, so that for a battery that uses the positive electrode material of the present disclosure as a positive electrode, normal-temperature and high-temperature cycling stabilities are improved obviously, and the battery has a high safety performance, a low internal resistance, and a high output power. Therefore, the positive electrode material of the present disclosure is applicable to a battery having a relatively high requirement on a safety performance.

The foregoing describes the implementations of the present disclosure. However, the present disclosure is not limited to the foregoing implementations. Any modification, equivalent replacement, improvement, or the like made without departing from the spirit and the principle of the present disclosure shall fall within the protection scope of the present disclosure.

What is claimed is:

1. A positive electrode material, wherein the positive electrode material comprises a positive electrode active material and a coating material on a surface of the positive electrode active material;
a median particle size Dv50 of the positive electrode material ranges from 2 μm to 7 μm; and
a chemical formula of the positive electrode active material is LiₐFeₓMn_{1-x-y-z}M_{y}N_{z}PO₄, wherein M and N are co-doping elements, 0.9≤a≤1.1, 0≤x≤1, 0≤y≤0.02, and 0≤z≤0.02.

2. The positive electrode material according to claim 1, wherein 0.96≤a≤1.1; and/or
M is selected from at least one of niobium, magnesium, cobalt, zinc, nickel, or copper; and/or
N is selected from at least one of aluminum, titanium, vanadium, or cerium; and/or
the positive electrode active material has an olivine-type structure.

3. The positive electrode material according to claim 1, wherein the positive electrode active material is a secondary spherical particle, the secondary spherical particle comprises a kernel region and a shell region, the shell region is disposed on an outer layer of the kernel region, and the shell region has an aggregated dense structure; and/or
the kernel region has an aggregated loose structure; and/or
a specific surface area of the positive electrode material ranges from 8 m²/g to 25 m²/g.

4. The positive electrode material according to claim 1, wherein the coating material comprises a carbon material; and/or
the coating material comprises amorphous carbon; and/or
a thickness of the coating material ranges from 2 nm to 10 nm.

5. The positive electrode material according to claim 1, wherein the positive electrode active material is LiₐMn_{1-y-z}M_{y}N_{z}PO₄.

6. The positive electrode material according to claim 5, wherein an electronic conductivity of LiₐMn_{1-y-z}M_{y}N_{z}PO₄ ranges from 1×10⁻⁵ S/cm to 9×10⁻⁵ S/cm; and/or
a lithium-ion diffusion coefficient of LiₐMn_{1-y-z}M_{y}N_{z}PO₄ ranges from 1×10⁻¹⁴ cm²/s to 8×10⁻¹⁴ cm²/s.

7. The positive electrode material according to claim 3, wherein the shell region or the kernel region or each of them has a pore; and/or
a porosity of the shell region ranges from 10% to 35%; and/or
a porosity of the kernel region ranges from 60% to 90%.

8. The positive electrode material according to claim 5, wherein a ratio of a mass of the positive electrode active material to a total mass of the positive electrode material ranges from 97.5 wt % to 99 wt %, and a ratio of a mass of the coating material to the total mass of the positive electrode material ranges from 1 wt % to 2.5 wt %.

9. The positive electrode material according to claim 5, wherein the positive electrode active material is a secondary spherical particle, the secondary spherical particle comprises a kernel region and a shell region, the shell region is disposed on an outer layer of the kernel region, and a median particle size Dv50 of the kernel region of the positive electrode active material ranges from 1.2 μm to 2.6 μm; and/or
the positive electrode active material is LiMnPO₄; and/or
the kernel region of the positive electrode active material is formed by aggregation of primary particles of LiMnPO₄ whose particle sizes range from 200 nm to 300 nm; and/or
the shell region of the positive electrode active material is formed by aggregation of primary particles of LiMnPO₄ whose particle sizes range from 300 nm to 500 nm.

10. The positive electrode material according to claim 5, wherein a thickness of the coating material ranges from 2 nm to 8 nm; and/or
a specific surface area of the positive electrode material ranges from 15 m²/g to 25 m²/g.

11. The positive electrode material according to claim 1, wherein the positive electrode active material is LiₐFeₓM_{y}N_{z}PO₄.

12. The positive electrode material according to claim 11, wherein an electronic conductivity of LiₐFeₓM_{y}N_{z}PO₄ ranges from 2×10⁻² S/cm to 9×10⁻² S/cm; and/or
a lithium-ion diffusion coefficient of LiₐFeₓM_{y}N_{z}PO₄ ranges from 1×10⁻¹¹ cm²/s to 9×10⁻¹¹ cm²/s.

13. The positive electrode material according to claim 11, wherein a thickness of the coating material ranges from 2 nm to 8 nm; and/or
a specific surface area of the positive electrode material ranges from 8 m²/g to 15 m²/g; and/or
a ratio of a mass of the positive electrode active material to a total mass of the positive electrode material ranges from 97.5 wt % to 99 wt %, and a ratio of a mass of the coating material to the total mass of the positive electrode material ranges from 1 wt % to 2.5 wt %.

14. The positive electrode material according to claim 11, wherein the positive electrode active material is a secondary spherical particle, the secondary spherical particle comprises a kernel region and a shell region, the shell region is disposed on an outer layer of the kernel region, and a median particle size Dv50 of the kernel region of the positive electrode active material ranges from 1.2 μm to 2.6 μm; and/or
the positive electrode active material is LiFePO₄; and/or
the kernel region of the positive electrode active material is formed by aggregation of primary particles of LiFePO₄ whose particle sizes range from 200 nm to 300 nm; and/or
the shell region of the positive electrode active material is formed by aggregation of primary particles of LiFePO₄ whose particle sizes range from 300 nm to 500 nm.

15. The positive electrode material according to claim 1, wherein in the chemical formula LiₐFeₓMn_{1-x-y-z}M_{y}N_{z}PO₄ of the positive electrode active material, 0≤x≤0.6; and/or
0.0015≤y+z≤0.04; and/or
a molar ratio of M to N ranges from 1:1 to 3:1.

16. The positive electrode material according to claim 15, wherein the positive electrode active material is a secondary spherical particle, the secondary spherical particle comprises a kernel region and a shell region, the shell region is disposed on an outer layer of the kernel region, and the shell region or the kernel region or each of them has a pore; and/or
a porosity of the shell region is greater than 0 and less than or equal to 30%; and/or
a porosity of the kernel region ranges from 65% to 90%; and/or
a median particle size Dv50 of the kernel region of the positive electrode active material ranges from 1 μm to 2.8 μm; and/or
a specific surface area of the positive electrode material ranges from 10 m²/g to 18 m²/g.

17. The positive electrode material according to claim 15, wherein in the positive electrode material, a mass ratio of the coating material to the positive electrode active material ranges from 1:100 to 2.5:100; and/or
a capacity per gram for discharging of the positive electrode material is greater than 150 mAh/g.

18. A positive electrode plate, wherein the positive electrode plate comprises the positive electrode material according to claim 1.

19. A battery, wherein the battery comprises the positive electrode material according to claim 1.

20. The battery according to claim 19, wherein a C-rate performance of the battery is greater than 90%; and/or
a cycling capacity retention rate of the battery after 1500 charge and discharge cycles is above 90%; and/or
an EIS impedance value of the battery is less than or equal to 6 mΩ.
